(19) United States
(12) Patent Application Publication
(10) Pub. No.: US 2025/0384358 A1
(43) Pub. Date: Dec. 18, 2025

(54) SYSTEMS AND METHODS FOR MANAGING AND COORDINATING THE RENTAL OF VEHICLE CHARGING STATIONS AND PARKING LOCATIONS

(71) Applicant: Savita Charging Innovations, Hanford, CA (US)

(72) Inventor: Rushi Panchal, Hanford, CA (US)

(21) Appl. No.: 19/296,914

(22) Filed: Aug. 11, 2025

Related U.S. Application Data
(63) Continuation-in-part of application No. 19/025,160, filed on Jan. 16, 2025, now abandoned.
(60) Provisional application No. 63/621,475, filed on Jan. 16, 2024.

(51) Int. Cl. G06Q 10/02; G06Q 50/06

(52) U.S. Cl. CPC G06Q 10/02; G06Q 50/06

(57) ABSTRACT

Systems for managing and coordinating the rental of charging stations and/or parking spaces may include a server and one or more mobile devices operatively connected to the server and having an application executing thereon. The application may be configured to coordinate rental reservation requests between a first and a second user of a charging station or parking space which is owned, or otherwise controlled, by the second user. Using a mobile device with the application, a user may search for available charging stations or parking spaces, make a reservation request for the same, and be provided with instructions for, and directions to, the charging station or parking space. A user may also use the mobile device with the application to make or receive payments for a rental. The application may also be configured to coordinate the exchange of a parking space from a first user to a second user.

### CROSS-REFERENCE TO RELATED APPLICATIONS

This application is a continuation-in-part of U.S. Nonprovisional patent application Ser. No. 19/025,160, filed Jan. 16, 2025, which claims priority to, and the benefit of, U.S. Provisional Patent Application No. 63/621,745, filed Jan. 16, 2024, each of which are hereby incorporated by reference in their entirety.

### FIELD OF THE INVENTION

The present invention concerns the management of rental vehicle charging stations and parking locations. More particularly, embodiments of the present invention concern systems and methods for managing and coordinating the rental of vehicle charging stations between users and owners. Some embodiments of the present invention also concern systems and methods for managing and coordinating the rental of parking spaces between users and between users and owners.

### BACKGROUND OF THE INVENTION

In 2019, there were approximately 380,000 electric vehicles sold in the United States. It is estimated that this number could approach 1,000,000 by 2023 and 3,000,000 by 2028. Most owners of electric vehicles have the ability to charge their electric vehicle at home or their place of employment through the use of privately owned equipment, such equipment of which is typically slower Level 1 (L1) chargers that operate on 120 volts or faster Level 2 (L2) chargers that operate on 240 volts. However, when traveling long distances away from home, owners of electric vehicles must rely on publicly available electric vehicle charging stations. Nonetheless, the number of public vehicle charging stations is dwarfed by the number of refueling stations (i.e., gas stations) for conventional fuel internal combustion engine vehicles, and the increase in rate of sale of electric vehicles is substantially faster than the rate of installation of new public vehicle charging stations.

Public electric vehicle charging stations are not sufficiently placed along commuter travel routes, and due to the lack of a sufficient numbers of public electric vehicle charging stations and the typical time that it takes to charge an electric vehicle, public charging is viewed as a last resort for electric vehicle owners. Electric vehicle owners must carefully plan their trip to arrive at a charging station well in advance of battery depletion, which is complicated by the fact that charging stations are typically off the beaten path and/or already in use by others at a time when the electric vehicle needs to be charged.

It is estimated that there are approximately 150,000 public vehicle charging stations in the US and over 1,600,000 home chargers in the US. Thus, aspects of the invention pertain to systems and methods for allowing electric vehicle owners to utilize, as an alternative to public vehicle charging stations, third party home chargers. Other aspects of the invention pertain to systems and methods for allowing people to lease parking space at private residences (including notably during special events where parking is limited). Still yet, other aspects of the invention pertain to systems and methods for allowing vehicle owners to swap public parking spaces.

### BRIEF SUMMARY OF THE INVENTION

In some embodiments, the present invention generally comprises a system for managing a network of electric vehicle chargers and coordinating the use thereof by third-party vehicle operators. More particularly, embodiments of the present invention concern systems and methods for vehicle operators to charge their vehicle using residential and/or business charging stations. In some embodiments, the present invention also comprises systems and methods for locating and renting parking spaces. More particularly, embodiments of the present invention concern systems and methods for vehicle operators to locate and rent residential and/or business parking spaces. In some embodiments, the present invention also comprises systems and methods for coordinating the exchange of parking spaces between vehicle operators. More particularly, embodiments of the present invention concern systems and methods for vehicle operators to locate and rent parking spaces held by other vehicle operators and coordinate the exchange of parking spaces between requestors and occupants of parking spaces.

In some aspects, the present invention concerns mobile or web-based software (referred to generally hereafter as “application”) which may be downloaded and/or accessed on a mobile or non-mobile device. In some embodiments, the application may be configured to manage a network of charging stations and coordinate the loaning or rental of charging stations by owners to vehicle operators who need to charge an electric (or plug-in hybrid) vehicle. The application may also, according to some embodiments, be configured to manage and coordinate the rental of parking spaces and the exchange of parking spaces between two vehicle operators. The application may comprise an interface for owners of parking locations/spaces and/or charging stations and an interface for vehicle operators, with some features and functionalities of the application being user specific.

Using the application, in some embodiments, a charging station owner may be able to register one or more charging stations and make them available for rental by vehicle operators. A charging station owner may be able to view the location(s) and status(es) of their charging station(s) at any time, as well as view data and analytics related thereto. In some embodiments, a charging station owner may be able to assign one or more managers to the charging station(s). According to some embodiments, a manager may be able to add, remove, and/or edit charging stations, as well as view their locations. In some embodiments, a manager may be able to approve or reject requests to reserve a charging station, as well as update the status of a charging station. In addition, a manager, according to some embodiments, may be able to view the status of payment transactions. In some embodiments, the application may use the location of an owner's or manager's mobile device to determine and record the location of a charging station.

Further to the above, and according to some embodiments, using the application, a vehicle operator may be able to view registered charging stations. In some embodiments, a vehicle operator may be able to view registered charging stations near their location or along a planned route. Furthermore, and according to some embodiments, a vehicle operator may be able to request the rental of a charging station. In some embodiments, a vehicle operator may also be able to pay for a rental using the application. While the vehicle of a vehicle operator is charging, according to some embodiments, the vehicle operator may be able to view the status of the charge and the amount of fees accrued. In some embodiments, the application may use the location of a vehicle or a vehicle operator's mobile device to determine when the vehicle is at a charging station, and when the vehicle has departed therefrom.

According to some embodiments of the present invention, using the application, a charging station owner may be able to register one or more parking spaces or stations (which may have one or more parking spaces) and make them available for rental by vehicle operators. As similarly described above with reference to charging stations, a parking station owner (like a charging station owner) may be able to view the location(s) and status(es) of their parking station(s) and space(s), as well as view data and analytics related thereto. In some embodiments, a parking station owner may assign one or more managers which may have capabilities similar to that of a charging station manager.

According to some embodiments of the present invention, using the application, a vehicle operator may be able to view registered parking spaces. As similarly described above with reference to charging stations, in some embodiments, a vehicle operator may be able to view registered parking spaces near their location or along a planned route. The capabilities of the application and vehicle operator as they relate to parking spaces and the rental thereof may be similar to the capabilities of the application and vehicle operator as they relate to charging stations.

According to some embodiments of the present invention, a system for managing and coordinating a rental of a charging station or parking space may include: (i) at least one server comprising a memory having a database and at least two mobile devices operatively connected to the at least one server, where each of the at least two mobile devices comprise an application executing thereon and where the application is configured to exchange a rental request between a first and a second of the at least two mobile devices, coordinate an arrangement of the rental, and facilitate payments to and from the users of the first and second mobile devices. In some embodiments, the application may be configured to generate a listing of available charging stations for a given location and/or time. The application may also, according to some embodiments, be configured to send a notification to the second mobile device, where the notification is associated with a request for the rental of a charging station. Furthermore, and according to some embodiments, the application may be configured to send a notification to the first mobile device, where the notification is associated the rental request. In some embodiments, the application may be configured to determine a location of a mobile device using the global positioning satellite (GPS) location thereof. Furthermore, and according to some embodiments, the application may be configured to determine a transit time to a charging station based on the GPS location of a mobile device and publicly accessible real-time traffic data (for example, and without limitation, Google Maps or Waze). In some embodiments, the application may be configured to exchange data between a mobile device and one or more charging stations connected to the internet.

According to some embodiments of the present invention, a method for coordinating the rental of an electric vehicle charger by a first party from a second party may comprise the steps of: (i) providing a listing of available charging stations in a defined area to the first party, each charging station having at least one electric vehicle charger; (ii) making a request for a rental of one of the available charging stations by the first party, wherein the one of the available charging stations is managed by the second party; (iii) sending the request to the second party; (iv) approving, by the second party, the rental request; (v) notifying the first party of the approved request and providing information about the rental, where the information may include a location of the rented charging station; (vi) plugging in a vehicle associated with the first party into the charger of the rented charging station; (v) charging the vehicle; (vi) once charged, unplugging the vehicle from the charger; (vii) facilitating payment by the first party for the rental; and (viii) facilitating payment to the second party for the rental.

Further to the above, in some embodiments, the first party may request rentals for a plurality of available charging stations, where the plurality of charging stations may be managed by the second party and/or one or more additional parties. Also, and according to some embodiments, the second party may reject the rental request, in which case the first party may be notified of the rejected rental request. In some embodiments, the information about the rental may further include a time (or time window) and a date. The second party may, according to some embodiments, propose an alternative rental time, in which case the first party may be notified of the proposed alternative rental time. If the first party is notified of a proposed alternative rental time, according to some embodiments, the first party may be provided options to accept or deny the proposed alternative rental time. If the first party denies the proposed alternative rental time, the second party may be notified and may be provided options to reject the rental request or accept the rental request with the original rental time. In some embodiments, the first party may send multiple requests to multiple second parties at the same time. For example, and without limitation, the first party may request rentals of a plurality of chargers within a geographic range, with each request being sent to the associated second party (i.e., charging station manager). Upon the acceptance of one of the plurality of rental requests, all other requests may be cancelled.

Further to the above, and according to some embodiments, after the first party is notified about the approved rental request, the first party may be notified when they must to depart from their current location to arrive at the rented charging station at the rental time. In some embodiments, while the vehicle is charging, each of the first party and the second party may be notified of the status of the charge. According to some embodiments, if the first party is not at the location of the rented charging station while the vehicle is charging, the first party may be notified when they must depart from their current location to arrive at the rented charging station upon completion of the charge. After completing the charge, according to some embodiments, if the vehicle is not removed from the rented charging station after a defined amount of time, the second party may be notified. Also, if the vehicle is not removed from the rented charging station after the defined amount of time, an additional payment by the first party may be facilitated and an additional payment to the second party may be facilitated. In some embodiments, once the vehicle has been removed from the rented charging station, the second party may be notified.

According to some embodiments of the present invention, a method for coordinating a rental of a parking space by a first party from a second party may comprise: (i) providing a listing of available parking spaces in a defined area to the first party, where one of the parking spaces is managed by the second party; (ii) making a request for a rental of the parking space managed by the second party; (iii) sending the rental request to the second party; (iv) approving, by the second party, the rental request; (v) notifying the first party of the approved request and providing information about the rental, where the information may include a location of the rented parking space; (vi) parking a vehicle associated with the first party in the parking space; (vii) facilitating payment by the first party for the rental; (viii) facilitating payment to the second party for the rental; (ix) removing the vehicle from the parking space; and (x) notifying the second party that the vehicle has been removed from the parking space.

Further to the above, in some embodiments, a portion of the payment from the first party and/or to the second party may be facilitated before the vehicle is parked. According to some embodiments, a portion of the payment from the first party and/or to the second party may be facilitated after the vehicle is removed from the parking space. In some embodiments, if the vehicle is not removed from the parking space after a specific time or given amount of time, a penalty may be imposed.

According to some embodiments of the present invention, a method for coordinating an exchange of a parking space between a first party and a second party may comprise: (i) parking a first vehicle in a parking space, where the first vehicle is associated with the first party; (ii) providing an estimated departure of the first vehicle by the first party; (iii) providing a listing to the second party of available parking spaces in a defined area, where the listing includes the parking space of the first vehicle; (iv) requesting a rental by the second party of the parking space of the first vehicle; (v) notifying the first party of the rental request; (vi) accepting the rental request; (vii) notifying the second party of the accepted rental request; (viii) meeting, by the second party, the first party at the parking space of the first vehicle; (ix) once the first vehicle and a second vehicle, associated with the second party, are in a position to exchange, removing the first vehicle from the parking space and parking the second vehicle in the parking space.

Further to the above, and according to some embodiments, the rental request may include a rental time. In some embodiments, if the first party is not at the parking space at the rental time, a penalty may be imposed. Similarly, and according to some embodiments, if the second party is not at the parking space at the rental time, a penalty may be imposed. Furthermore, in some embodiments, if the first party is not at the parking space after a period of time following the rental time, a penalty may be imposed. Similarly, in some embodiments, if the second party is not at the parking space after a period of time following the rental time, a penalty may be imposed. According to some embodiments, if the second party does not park the second vehicle in the parking space after the first vehicle has left, a penalty may be imposed. Similarly, and according to some embodiments, if the first party does not remove the first vehicle from the parking space, a penalty may be imposed.

In some embodiments, the present invention provides for a parking management system which may be adapted for managing parking locations in large areas. A parking management system may be accessible only certain users, such as owners or managers, or certain features and functions may only be accessible to certain users. In some embodiments, a parking management system may comprise a plurality of modules which may include tools, data, and/or analytics. According to some embodiments of the present invention, a parking management module may provide a user with the ability to view and manage parking locations within a given area. In some embodiments, a user may be able to view the occupancy of a parking location.

In some embodiments of the present invention, a parking management system may include a parking listings module which may provide a listing of parking locations and the parking spaces located therein, as well as information related to the parking locations and spaces. In some embodiments of the present invention, a parking management system may include a parking violations module which may provide a listing of parking violations and information related thereto. According to some embodiments, a parking management system may include a revenue report module which may provide financial information related to parking locations and parking spaces. In some embodiments, a parking management system may include a parking report module which may provide statistical information related to parking locations and parking spaces.

According to some embodiments of the present invention, a user may search for parking locations on a map integrated with the application. In some embodiments, the map may show parking locations near the current location of the user or near a location set by the user. The user may, in some embodiments, be able to view parking locations within a desired area as a list. According to some embodiments, the user may set certain parameters for the search, as well as view photographs of, and information related to, a parking location. In some embodiments, upon selection of a parking location, a user may be able to view parking spaces within the selected location and select a parking space. According to some embodiments, a user may be able to view parking rates and/or charging station availability for parking spaces. According to some embodiments, a user may be able to view a layout of parking spaces corresponding to the approximate physical arrangement of the parking spaces.

In some embodiments, if a user is not near their desired parking location, the user may be able to view parking spaces within the parking location, but may not be able to reserve a parking space until the user is within a specified distance from the parking location or parking space. Alternatively, in some embodiments, a user may first enter a parking location and then view and select a parking space, which may be available immediately for rental.

According to some embodiments, once a parking space is selected and the rental thereof is confirmed, a timer may start and may continue to run until the user decides to end the rental. In some embodiments, during a rental, a user may be able view an active timer and a real-time cost of the rental. Once a user is ready to leave a parking space, in some embodiments, they may end the rental of the space and pay. In some embodiments, prior to ending a rental, a user may be provided with a total cost of the rental, including any additional fees. According to some embodiments, a discount code or a gift card or certificate number, may be provided as payment. Upon payment, in some embodiments, a user may be provided with proof of payment.

According to some embodiments, a user may be provided with an option to report when a reserved parking space is visually identified as available by the user. Once a misidentification has been reported and resolved, in some embodiments, a user may proceed to confirm a rental of the misidentified parking space. According to some embodiments, a user may be able to report a suspected parking violation. In some embodiments, if a violation is suspected, a user may be able to select an option to report the violation, and then enter and submit information related to the violation. By reporting a parking violation, an owner may be able to take action to resolve the issue. In some embodiments, if a parking violation has occurred on private property, an owner or property manager may request towing services to remove the vehicle in violation.

According to some embodiments of the present invention, a system for managing and coordinating reservations of parking spaces may comprise: a) a remote server having a processor, processor-executable instructions stored in a memory associated with the processor, and a storage element associated with the processor, wherein the storage element may comprise: i) a space-record database for storing a plurality of space records; ii) a user-record database for storing a plurality of user records; and iii) a reservation-record database for storing a plurality of reservation records; b) a listing-agent device operatively connected to the server; and c) a vehicle-agent device operatively connected to the server, wherein the vehicle-agent device may comprise a location module for determining a location of the vehicle-agent device and a camera module for obtaining an image; wherein the instructions may be configured to cause the processor to: i) create a space record in response to receiving a listing request from the listing-agent device; ii) modify a space record in response to receiving a listing update from the listing-agent device; iii) identify available parking spaces in response to receiving a space availability query from the vehicle-agent device, and provide the available spaces to the vehicle-agent device; iv) create a reservation record associated with a corresponding space record and a corresponding user record in response to receiving a reservation request from the vehicle-agent device; and v) validate a start of a reservation and initiating a timer in response to receiving a start-verification from the vehicle-agent device.

In some embodiments, the vehicle-agent device may be configured to send a discrepancy package to the server, wherein the discrepancy package may comprise a location and an image of an observed parking space associated with a space record, and wherein the server instructions may be further configured to cause the processor to compare the discrepancy package with an availability status of a space record corresponding to the parking space, and, as a result of the comparison, modify the corresponding space record and the reservation record.

In some embodiments, the server instructions may be further configured to cause the processor to send a notification to the listing-agent device, wherein the notification may identify a change in the availability status of the space record as a result of the discrepancy package.

In some embodiments, when the parking space is observed to be available and the availability status of the space record is “unavailable”, the server instructions may be further configured to cause the processor to modify the space record to change the availability status to “temporarily withheld” to indicate that the parking space may be exclusively available for reservation by the vehicle-agent device.

In some embodiments, the server instructions may be further configured to cause the processor to, in response to receiving a reservation request from the vehicle-agent device: modify the reservation record to associate the reservation record with the space record; and, if a parking space was previously reserved by the vehicle-agent device, change an availability status of a space record corresponding to the previously reserved parking space to “available”.

In some embodiments, the server instructions may be further configured to cause the processor to change the recorded status to “available”, if the server fails to receive from the vehicle-agent device a reservation request before the expiration of a temporary hold time.

In some embodiments, the server may be configured to log a parking violation associated with the space record and send a notification identifying the parking violation to the listing-agent device, when the parking space is observed to be unavailable and the availability status of the space record is “available”.

In some embodiments, the listing-agent device may be configured to send a violation verification package to the server, wherein the violation package may comprise an image and a location of the parking violation associated with the space record and wherein the server may be configured to: log a confirmation of the parking violation based on the violation package; and determine if the parking violation was committed by a violating user in the user-record database.

In some embodiments, the server may be configured to send a notification to a vehicle-agent device associated with the violating user, wherein the notification may identify a demand for payment and/or a warning that a vehicle associated with the violating user may be towed.

In some embodiments, the server may be configured to dispatch a towing service to tow the vehicle.

In some embodiments, the reservation record may comprise a maximum reservation time, wherein the server may be configured to monitor an elapsed time determined by the timer of a reservation associated with the reservation record, wherein, if the elapsed time exceeds the maximum reservation time, a time violation occurs, and wherein, if the time violation occurs, the server may be configured to send a notification to the vehicle-agent device, wherein the notification may identify the time violation and that a surcharge may apply to the reservation.

In some embodiments, the space record may comprise an indication of whether a corresponding parking space has electric vehicle charging facilities and a cost associated with charging, wherein the reservation record may comprise an indication of whether the charging facilities will be used during the reservation, wherein the server may be configured to: log charge-status data; and send one or more notifications to the vehicle-agent device indicating a change in a status of the charging facilities.

In some embodiments, the server may be configured to: calculate a charging cost based on the charge-status data; calculate a reservation cost based on the charging cost and an elapsed time determined by the timer; and update the reservation record to include the reservation cost.

In some embodiments, the server may be configured to send route data to the vehicle-agent device, wherein the route data may comprise directions from the vehicle-agent device to a location associated with the reservation record, wherein a user interface of the vehicle-agent device may be configured to display a map and route guidance based on the route data, and wherein the vehicle-agent device may be configured to periodically send location information associated with the vehicle-agent device to the server.

In some embodiments, the server may be configured to end the reservation when a geolocation of the vehicle-agent device is within a specified distance from a location associated with the reservation record or the server receives a request to end the reservation from the vehicle-agent device.

In some embodiments, the user record may comprise at least one pre-authorized payment method and wherein the server may be configured to: calculate a reservation cost; facilitate payment from the vehicle-agent device; and facilitate payment to the listing-agent device.

In some embodiments, the space record may comprise an indicator of whether the space has access control facilities, wherein the server may be configured to: issue and send an access credential to the vehicle-agent device and/or the access control facilities when a geolocation of the vehicle-agent device may be within a specified distance from the access control facilities; and log an event corresponding to the opening of the gate.

In some embodiments, the space record may comprise a parking size, a location type, a charger descriptor, and environment descriptors.

In some embodiments, the space record may comprise a tenant identifier, an on-premise rate, an off-premise rate, and a boundary of a premise, wherein the server may be configured to: update the reservation record to charge the on-premise rate when the vehicle-agent device is within the boundary; and update the reservation record to charge the off-premise rate when the vehicle-agent device is outside of the boundary.

In some embodiments, the space record may comprise a rate change delay and wherein the server may be configured to update the reservation record to charge the on-premise rate for a duration of the delay when the vehicle-agent device is outside of the boundary.

### BRIEF DESCRIPTION OF THE DRAWINGS

FIGS. 1A-1H are diagrams illustrating exemplary user interfaces of an application, in accordance with some embodiments of the present invention.

FIGS. 2A-2F are diagrams illustrating exemplary user interfaces of an application, in accordance with some embodiments of the present invention.

FIGS. 3A-3F are diagrams illustrating exemplary user interfaces of an application, in accordance with some embodiments of the present invention.

FIGS. 4A-4F are diagrams illustrating exemplary user interfaces of an application, in accordance with some embodiments of the present invention.

FIGS. 5A-5F are diagrams illustrating exemplary user interfaces of an application, in accordance with some embodiments of the present invention.

FIGS. 6A-6G are diagrams illustrating exemplary user interfaces of an application, in accordance with some embodiments of the present invention.

FIG. 7 is a flowchart illustrating an exemplary method for coordinating the rental of an electric vehicle charger from a charging station operator by a vehicle operator, in accordance with some embodiments of the present invention.

FIG. 8 is a flowchart illustrating an exemplary method for coordinating the exchange of a parking space between a Current Occupant and a Prospective Occupant, in accordance with some embodiments of the present invention.

FIG. 9 is a flowchart illustrating an exemplary communication structure of an application operatively connected to a plurality of networks by means of an API broker, in accordance with some embodiments of the present invention.

FIGS. 10A-10I are diagrams illustrating exemplary user interfaces of an application, in accordance with some embodiments of the present invention.

FIGS. 11A-11J are diagrams illustrating exemplary user interfaces of an application, in accordance with some embodiments of the present invention.

FIGS. 12A-12F are diagrams illustrating exemplary user interfaces of an application, in accordance with some embodiments of the present invention.

FIGS. 13A-13I are diagrams illustrating exemplary user interfaces of an application, in accordance with some embodiments of the present invention.

FIGS. 14A-14H are diagrams illustrating exemplary user interfaces of an application, in accordance with some embodiments of the present invention.

FIGS. 15A-15H are diagrams illustrating exemplary user interfaces of an application, in accordance with some embodiments of the present invention.

FIGS. 16A-16H are diagrams illustrating exemplary user interfaces of an application, in accordance with some embodiments of the present invention.

FIGS. 17A-17F are diagrams illustrating exemplary user interfaces of an application, in accordance with some embodiments of the present invention.

FIGS. 18A-18F are diagrams illustrating exemplary user interfaces of an application, in accordance with some embodiments of the present invention.

FIGS. 19A and 19B are diagrams illustrating exemplary user interfaces of an application, in accordance with some embodiments of the present invention.

FIGS. 20A-20L are diagrams illustrating exemplary user interfaces of an application, in accordance with some embodiments of the present invention.

FIGS. 21A-21K are diagrams illustrating exemplary user interfaces of an application, in accordance with some embodiments of the present invention.

FIGS. 22A-22F are diagrams illustrating exemplary user interfaces of an application, in accordance with some embodiments of the present invention.

FIGS. 23A-23B are diagrams illustrating exemplary user interfaces of an application, in accordance with some embodiments of the present invention.

FIG. 24 is a flowchart illustrating an exemplary method for renting a parking space.

FIGS. 25A-25N are diagrams illustrating exemplary user interfaces of an application, in accordance with some embodiments of the present invention.

FIGS. 26A-26I are diagrams illustrating exemplary user interfaces of an application, in accordance with some embodiments of the present invention.

FIG. 27 is a flowchart illustrating an exemplary method for exchanging a parking space between a current occupant and a prospective occupant.

FIG. 28 is a diagram illustrating an exemplary system for managing reservation rentals, in accordance with some embodiments of the present invention.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

According to some embodiments of the present invention, an application, which may be mobile or web-based software operating on a mobile or non-mobile device, may be configured to (i) manage a network of electric vehicle charging stations, (ii) coordinate the rental of charging stations to third-party vehicle operators, and (iii) interface with third-party software to exchange information therebetween. Furthermore, and according to some embodiments of the present invention, the application may be configured to (i) manage a network of parking spaces and (ii) coordinate the rental of parking spaces to third-party vehicle operators. Additionally, and according to some embodiments of the present invention, the application may be configured to coordinate the exchange of a parking space held by a first party with a second party.

### Application Interfaces and Features

In some embodiments, the application may comprise multiple interfaces which may be specific to the type of user of the application, and features and functionalities of the application may vary depending on the type of user. For example, there may generally exist two main types of users of the application-a station operator user and a vehicle operator user. A station operator user may be an owner of one or more electric vehicle chargers and/or parking locations/spaces who, using the application, offers the use of its charger(s) and/or parking spaces to vehicle operator users. In some embodiments, a station operator user may be a manager or another person who is otherwise granted the responsibility of managing an owner's charging station(s). For example, a station owner may designate a manager of a charging station. A station operator user may allow a manager to create a separate user whose features and capabilities may, in some embodiments, be the same as a station owner user or, according to other embodiments, may be limited relative to the features and capabilities of a station owner. It is to be appreciated that a station operator may be the owner of a home or rental property which may have one or more chargers and/or parking spaces. A station operator may also be, in some embodiments, a designated representative of a municipality with jurisdiction over one or more stations, such as a city or town.

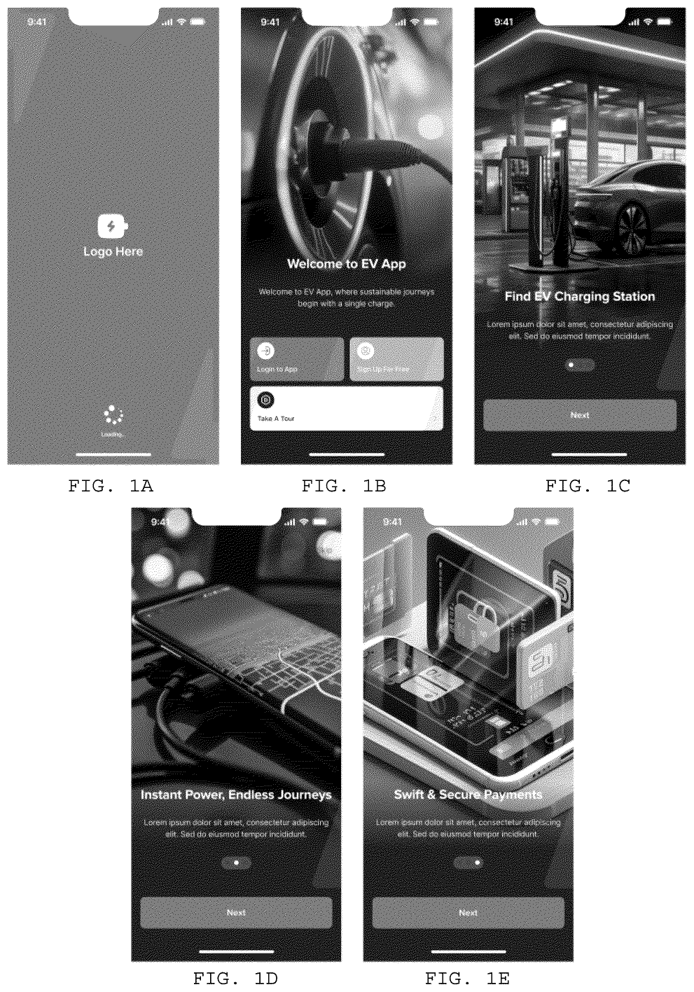

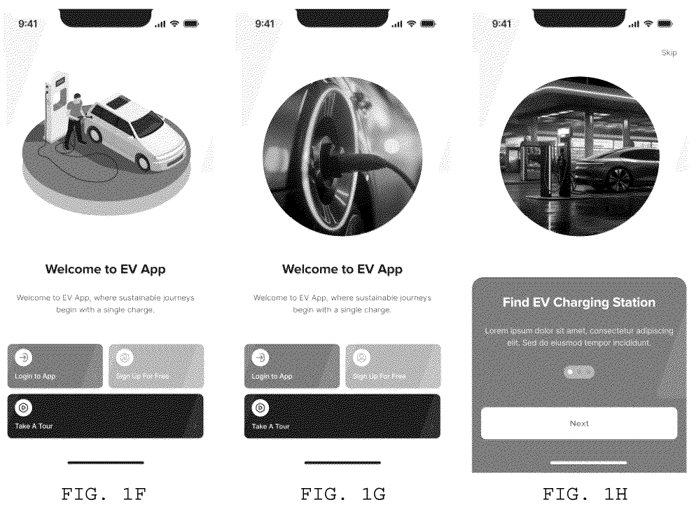

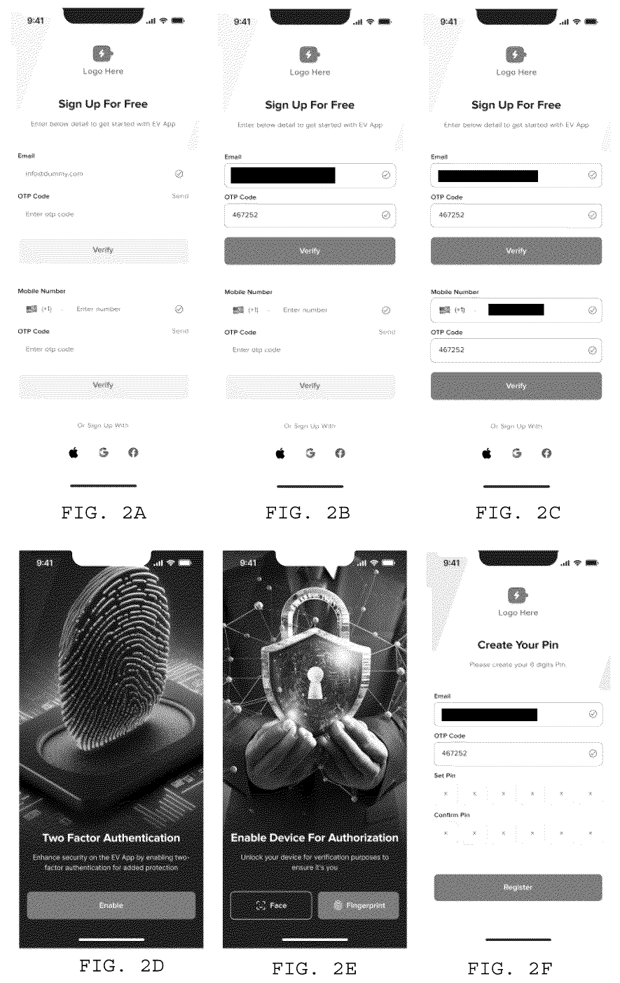

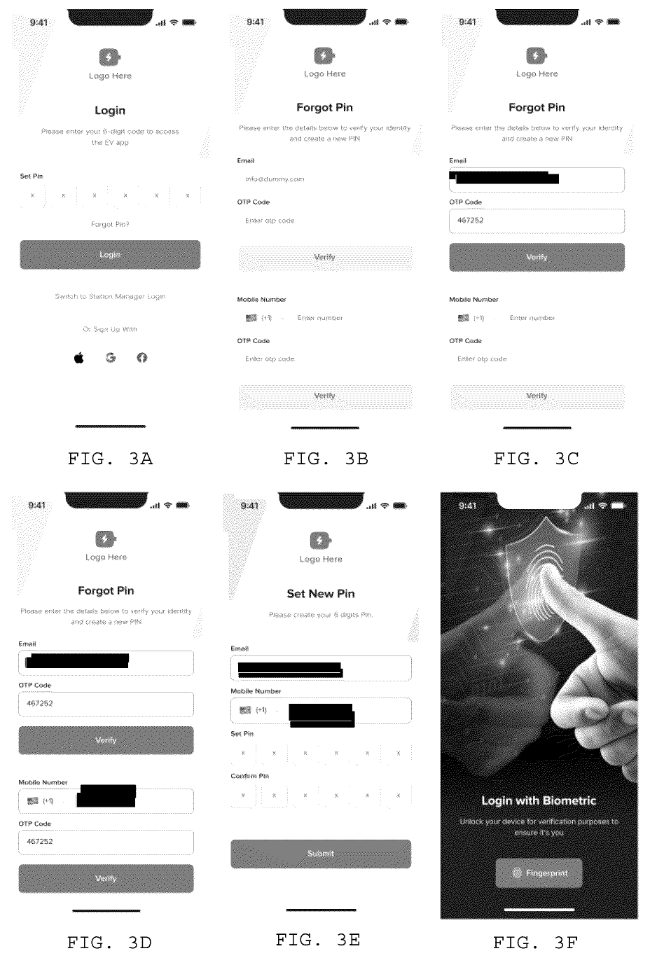

According to some embodiments of the present invention, before registering a charging and/or parking station (as a station operator user) or before searching for available charging and/or parking stations (as a vehicle operator user) a user may first create an account. For example, and with reference generally to FIGS. 1A-1H and 2A-2F, a user may select an option in the application to sign up as a user of the application. During the sign-up process, the user may provide an email address which may be verified by a one-time password. The user may also provide a phone number which may also be verified by a one-time password. Once both the email address and phone number of the user have been verified, the user may create a personal identification number (PIN) and complete registration. Optionally, and as illustrated in FIGS. 2D and 2E, for example, the user may be provided an option to enable two-factor authentication to sign in to their account. With reference, for example, to FIGS. 3A-3F, to log in, the user may provide their registered email address and PIN. Optionally, the user may be required to provide another means of authentication, such as, but not limited to, a fingerprint or face scan.

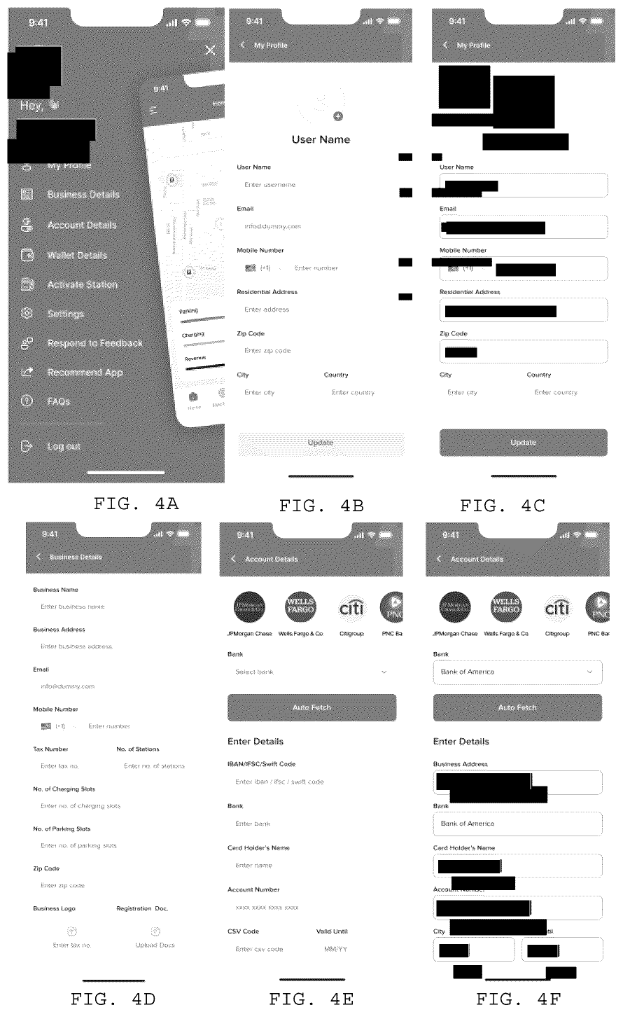

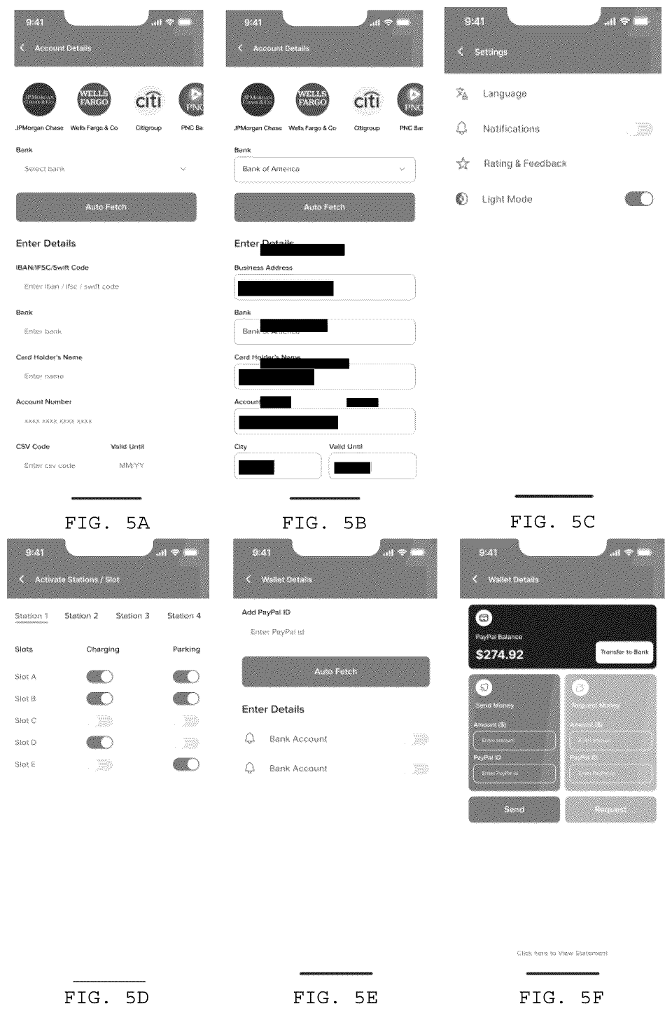

Once logged into the application, a user can access their account information and provide additional information which may be required before a user can offer a charging and/or parking station or search for a station. For example, and with reference generally to FIGS. 4A-4F, a station operator user may provide personal information such as a residential address. If applicable, the station operator user may also enter information about a related business. The station operator user may also provide a total number of charging and/or parking spaces to be offered to vehicle operator users. With reference, generally, to FIGS. 5A-5F, for example, the station operator user may also provide bank and/or payment information to allow the application to facilitate payments to and from the station operator user. In some embodiments, some information may be automatically fetched from a bank or intermediary payment service using one or more application programming interfaces (APIs). A user may also be able to view an account balance of an integrated bank or intermediary payment service, as illustrated, for example, in FIG. 5F. In some embodiments, a user may be able to transfer or request money, as well as transfer money held by an intermediary payment service to a bank.

According to some embodiments of the present invention, an established station operator user may register one or more charging and/or parking stations (which may be generally referred to as station(s)), where a station may comprise one or more spaces. In some aspects, a station may comprise only charging spaces or, in other aspects, a station may comprise only parking spaces, or, in other aspects, a station may comprise a combination of charging and parking spaces. In some embodiments, a charging space may also be designated as a parking space. To register a station, a station operator user may provide information about the station such as, but not limited, the number of charging and parking spaces, the location of the station, technical details about the charger(s) (e.g., brand, type, speed, etc.), length of the power cord(s), connector type(s), accessibility features (e.g., clearance for certain vehicles, handicap access, enclosed, covered, uncovered, etc.), expected window of availability (e.g., available day(s) and time(s)), and amenities provided at or near the station.

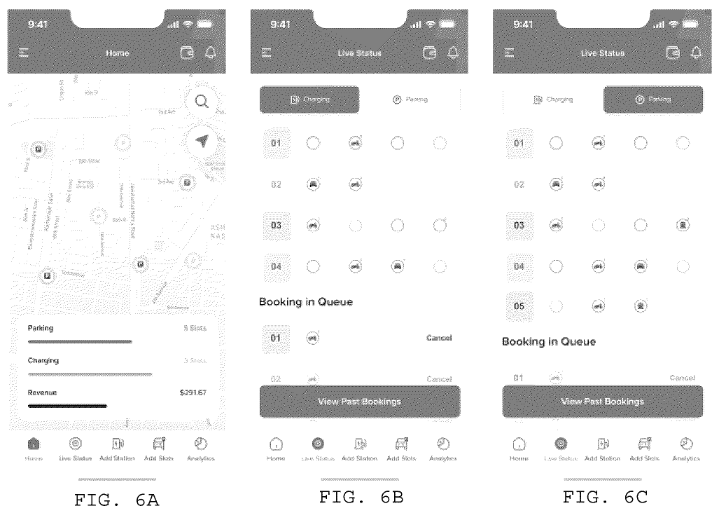

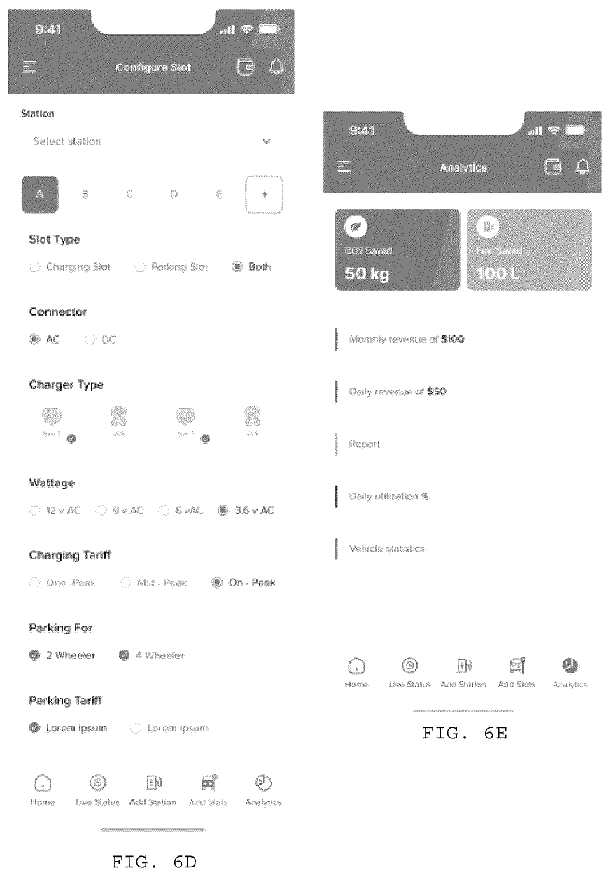

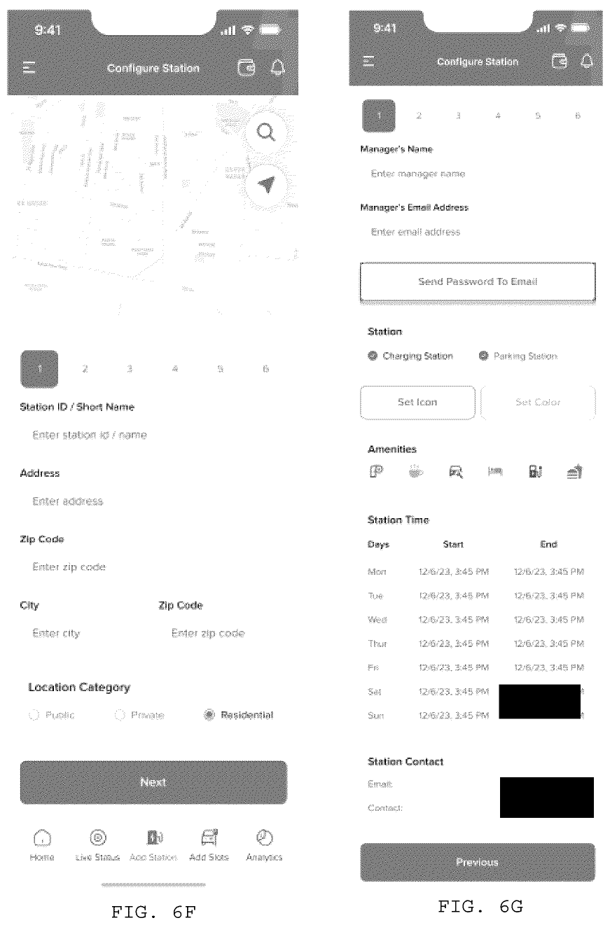

Once a station operator user has registered a station, according to some embodiments, a station operator user may be able to view and edit the activation status of individual spaces of their stations. For example, as illustrated in FIG. 5D, a station operator user may toggle the activation status of charging and parking spaces of an individual station. It is to be appreciated that, and as further illustrated in FIG. 5D, a station operator user may have the option to designate or redesignate a space as either a charging or parking space, or a combined charging and parking space. In some embodiments, a station operator user may be able to view their station(s) on a map which may be native to the application or integrated third-party software (via an API). In this view, a station operator user may be able to view the location(s) of their station(s), the status of the station(s) availability, and the total revenue received from their station(s) (which may be a lifetime total or over a specific timeframe), as illustrated, for example, in FIGS. 6A and 6E. A station operator user may also be able to access a more detailed view of the status(es) of their station(s). For example, and with further reference to FIGS. 6B and 6C, a station operator user may be able to view which space(s) of which station(s) are active and available, active and unavailable (i.e., in use), and inactive. For a space that is in use, a station operator user may also be able to view information related to the vehicle (or vehicle user) that is currently in the space. As further illustrated in FIGS. 6B and 6C, for example, a station operator user may be able to view upcoming and past rentals.

According to some embodiments, a station operator user may be able to accept or reject requests by vehicle users to reserve a charging or parking space. A station operator user may also be able to cancel accepted rentals prior to the start of the reserved charging or parking time, as illustrated, for example, in FIGS. 6B and 6C. In accordance with some embodiments of the present invention, a station operator user may be able to configure (or reconfigure) properties and options of a station or space, which may be done at any time or only during specific windows, such as when the station or space is not in use or temporarily deactivated. For example, and with reference to FIG. 6D, a station operator user may configure properties such as, but not limited to, the space type (charging, parking, or both), connector type (AC or DC), charger wattage, allowed vehicle types. A station operator user may also be able to modify fee options, such as, but not limited to, fees for use during peak energy hours or for parking a vehicle beyond the charge time or reserved time limit.

In some embodiments, a station operator user may be able to view analytics related to their station(s). For example, and with reference to FIG. 6E, a station operator user may be able to view statistics such as monthly and daily revenue, approximate amounts of carbon dioxide and fuel saved, and daily utilization of their station(s). According to some embodiments, a station operator user may also be able to access a detailed report on their station(s) and/or space(s). Additionally, in some embodiments, a station operator user may be able to view statistics related to the vehicle of users who have past, active, or future bookings for the station operator user's station(s). In some embodiments, station operator user may also be able to view the status of payment transactions.

According to some embodiments, a station operator user may optionally assign one or more managers to a station. For example, and with reference to FIG. 6G, a station operator user may enter a name and email address of a manager to be assigned to a station which may allow the manager to create an account as a station manager user. It is to be appreciated that a station manager user may have the same features and capabilities available to them as a station operator user, or a station operator user may selectively limit what features and capabilities the station manager user has. It is also to be appreciated that a station operator user may allow certain features and capabilities to a station manager user that the station operator user does not have (such as in cases where a station operator user wants to delegate certain responsibilities to one or more station manager users).

In order for a vehicle operator to request the rental of a charging or parking space (or the exchange of a parking space, described hereafter), the vehicle operator may establish an account as a vehicle operator user. It is to be appreciated, however, that, according to some embodiments, a user may be able to request a rental without first establishing account (e.g., by entering required or necessary information for a one-time rental only). The process of registering and setting up an account for a vehicle operator user is similar to that of a station operator user as it relates to credential requirements, password security, providing personal information, payment/bank information, etc. However, a vehicle operator user may not be able to register a station or view detailed information about registered stations. Unlike a station operator user, a vehicle operator user may need to provide information related to their vehicle(s).

According to some embodiments, once registered, a vehicle operator user may be able to search for and view charging and parking spaces offered by station operator users. In some embodiments, a vehicle operator user may be able to search for nearby available charging and parking spaces or those within a specified area. A vehicle operator user may also be able to search for available charging and parking spaces along a planned route. In some embodiments, a vehicle operator user may be able to view temporarily unavailable charging and parking spaces and the times that the spaces are expected to be available. A vehicle operator user can, according to some embodiments, filter search results by a specific time or timeframe, charger types and features, charging station features, etc. In some embodiments, a search may be automatically filtered according to information related to the vehicle of a vehicle operator user.

According to some embodiments of the present invention, when a vehicle operator user is charging a vehicle or has parked their vehicle in a parking space, they may be able to view the status of the charge (if charging) and monitor the amount to be paid as well as the charging or parking time. Once complete or the vehicle has left the space, payment may be automatically made or the vehicle operator user may be prompted to make payment through the application. In some embodiments, all or a portion of the total cost may be paid in advance of the rental. For example, a vehicle operator user may prepay a fixed amount to reserve a charging space such that once the amount is reached, charging automatically stops. Other charges, such as the fees previously described, may be applied whether or not the vehicle operator user has made a prepayment (in the case where, for example, a vehicle operator user does not timely remove their vehicle from the reserved space).

In accordance with some embodiments of the present invention, the application may also provide the ability for a vehicle operator user to offer a parking space currently occupied by the vehicle operator user to another vehicle operator user. To offer a parking space, a vehicle operator user may provide the location of space (which may obtained using the GPS location of a user's mobile device or vehicle), along with any other additional information such as, but not limited to, a photograph of the space and surrounding area and/or a description of the space and surrounding area. To reserve a parking space, a vehicle operator user may search for available parking spaces in a specified area and/or time. The vehicle operator user may then request the rental of a parking space from another vehicle operator user and the application may coordinate the exchange of the parking space between vehicle operator users.

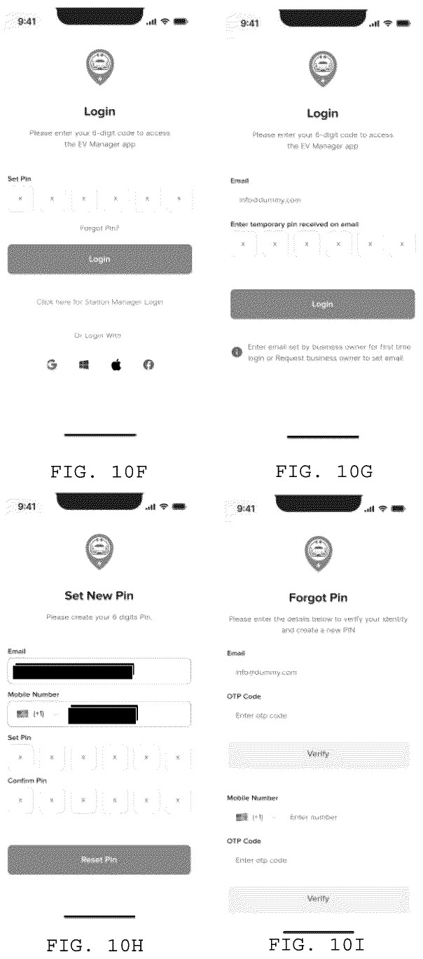

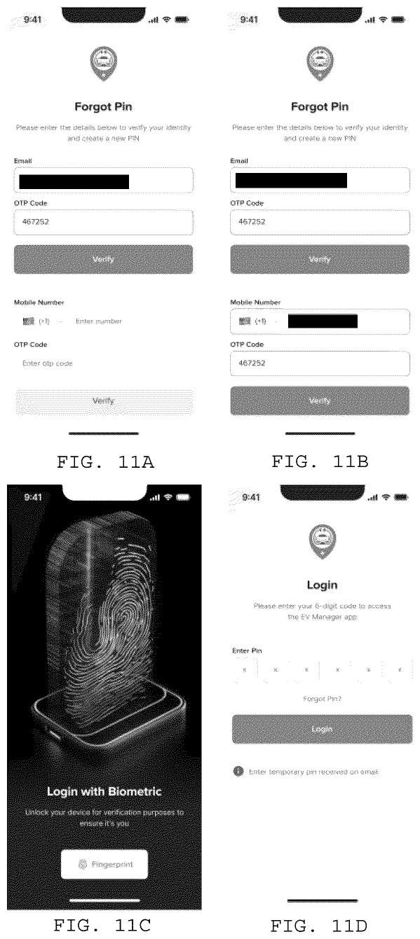

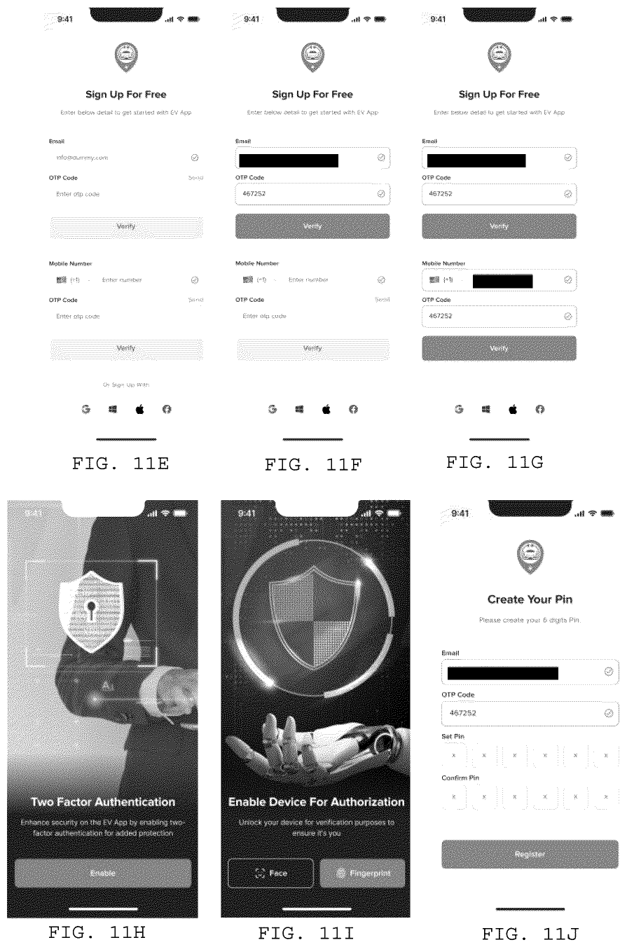

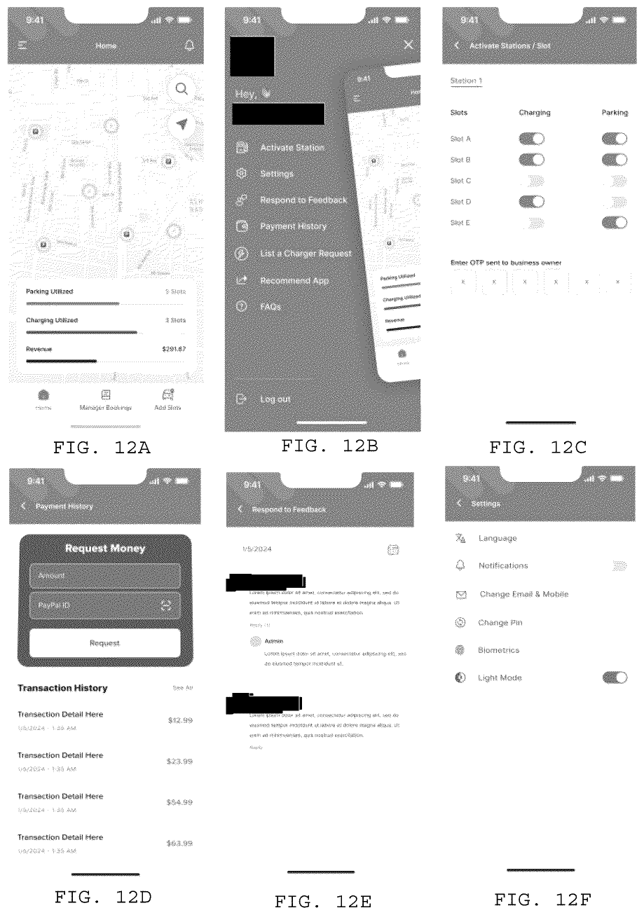

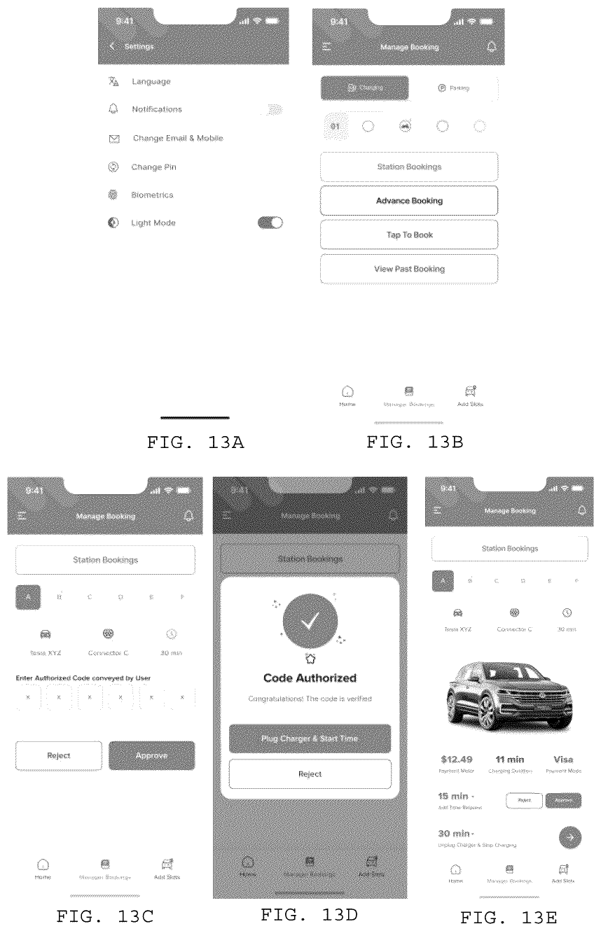

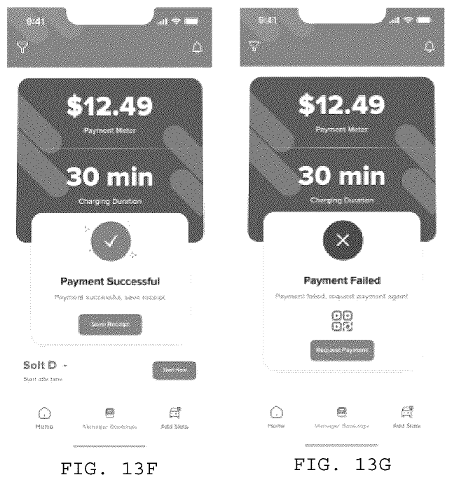

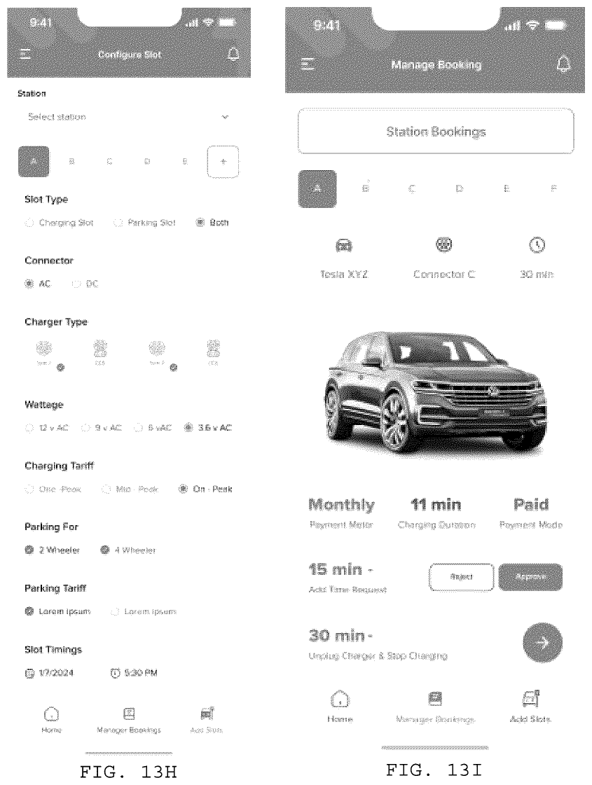

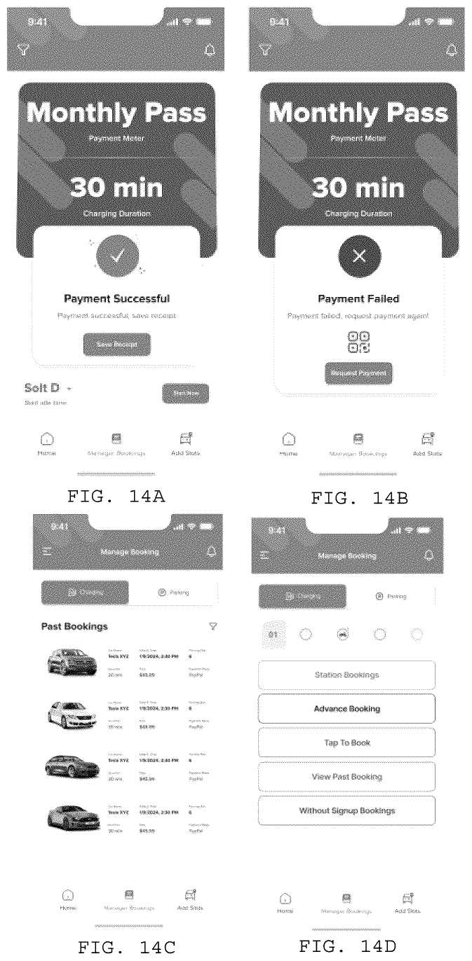

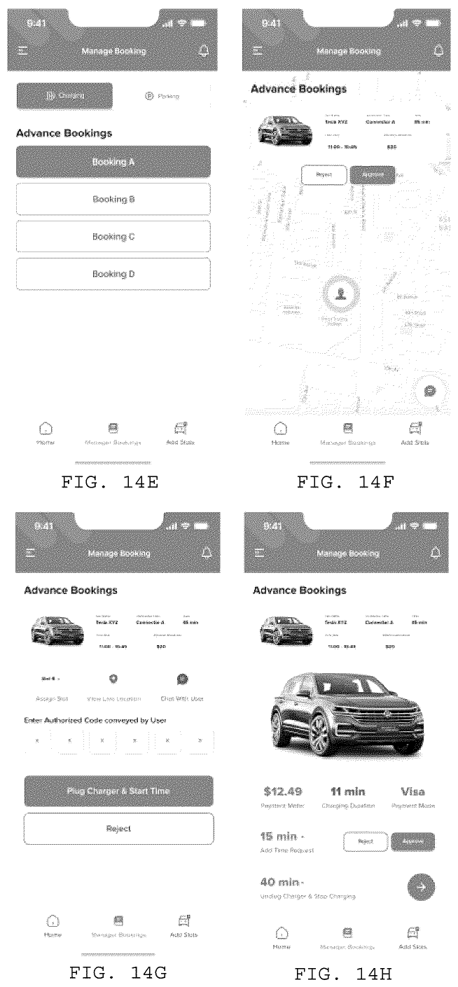

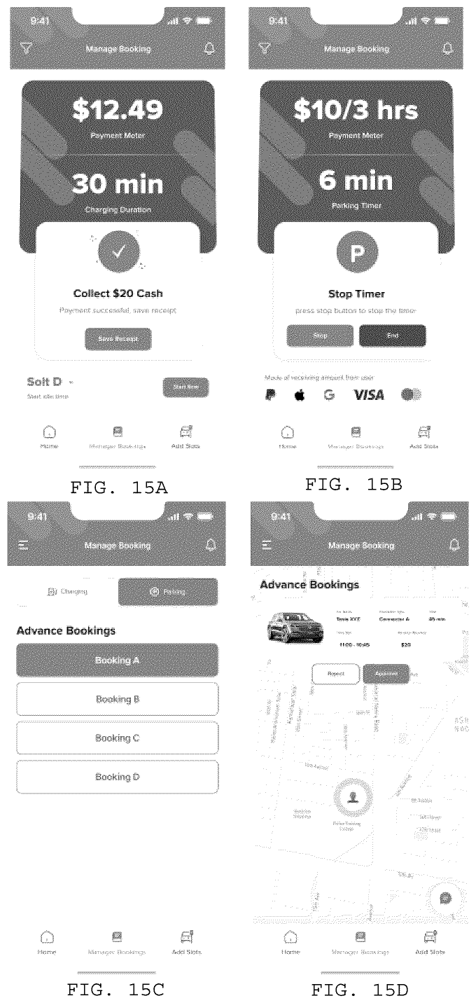

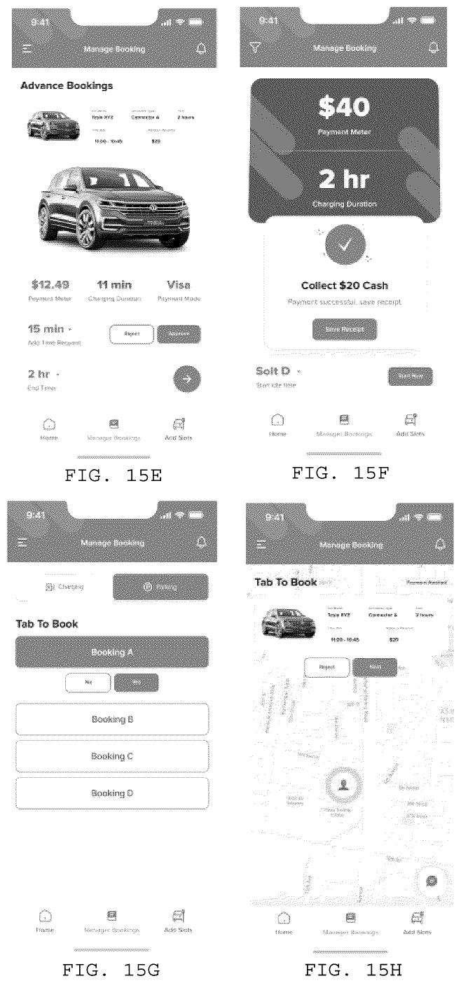

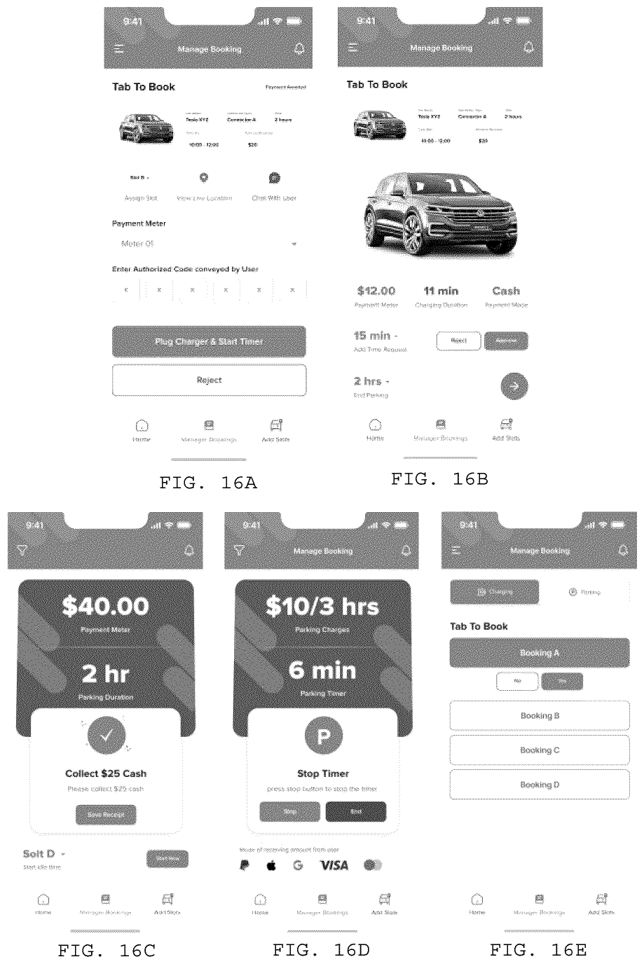

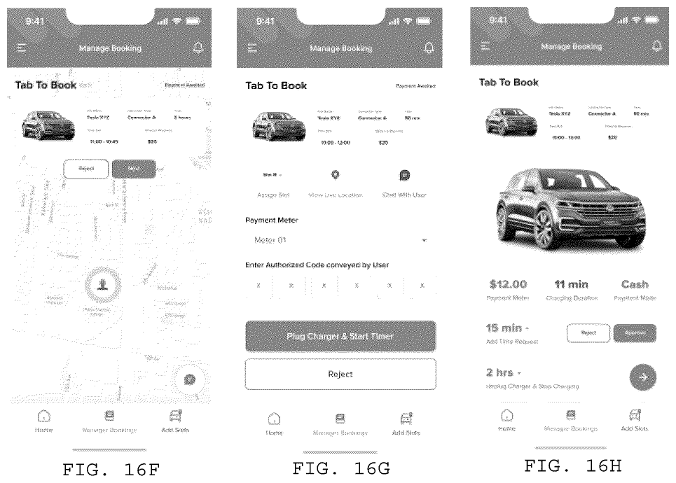

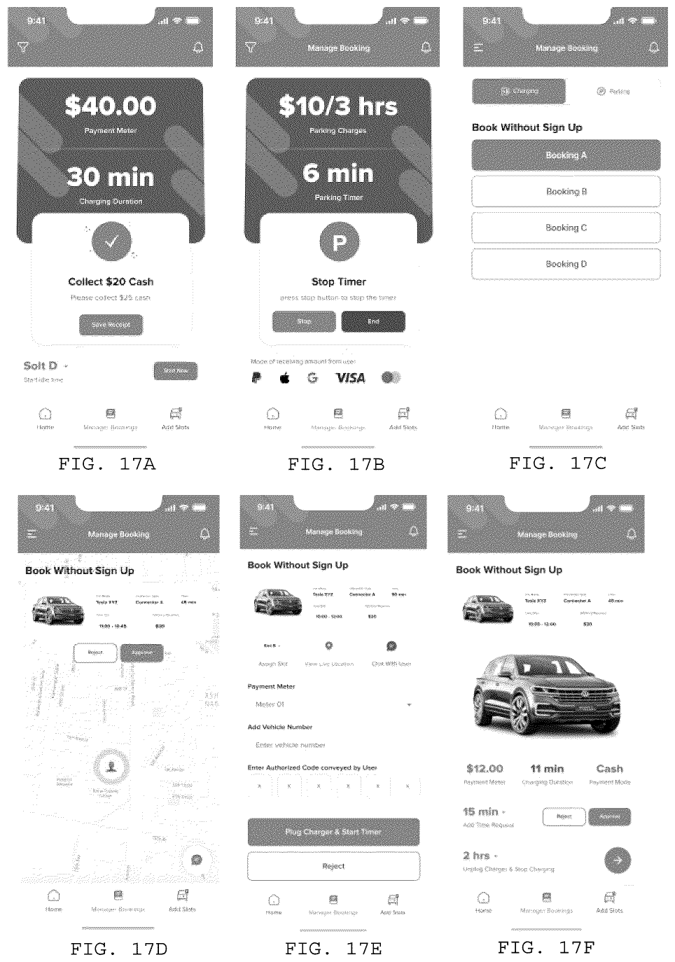

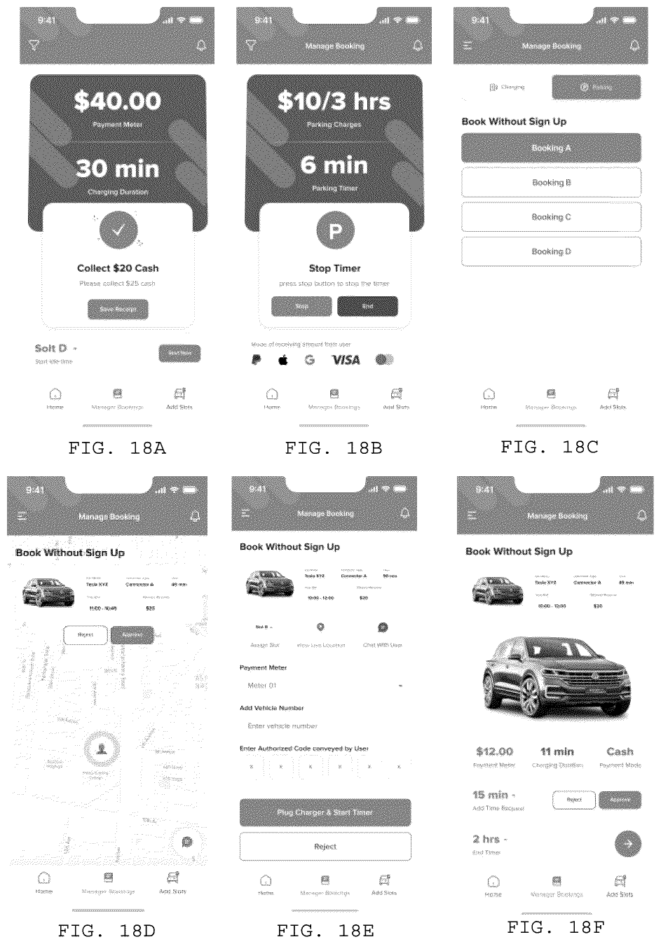

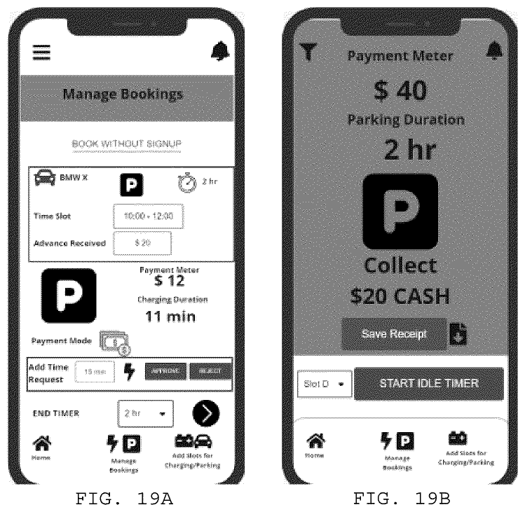

Further reference is made to FIGS. 10A-19B which are exemplary user interfaces which illustrate features and functions of the application described above, as well as heretofore. For example, FIGS. 10A-11J illustrate exemplary login and sign-up interfaces and FIGS. 12A-19B illustrate exemplary interfaces for managing stations and spaces, as well as rentals. With particular reference to FIGS. 13C and 13D, and according to some embodiments, in order to approve a rental, a unique code must be provided in the application. With reference to FIG. 13G, and according to some embodiments, in the event that a payment from a vehicle operator fails, a station operator may request payment.

According to some embodiments, the present invention provides a system for managing parking locations (generally referred to hereafter as “parking management system”) within a given area, and may be particularly adapted for the management of parking locations in large areas, such as a town or a city, or other type of municipality. In some embodiments, a user must be registered in order to access the parking management system. As described heretofore, the parking location management system may be accessible only certain users, such as parking location owners or managers (which may be city or town officials, for example), or certain features and functions may only be accessible to certain users.

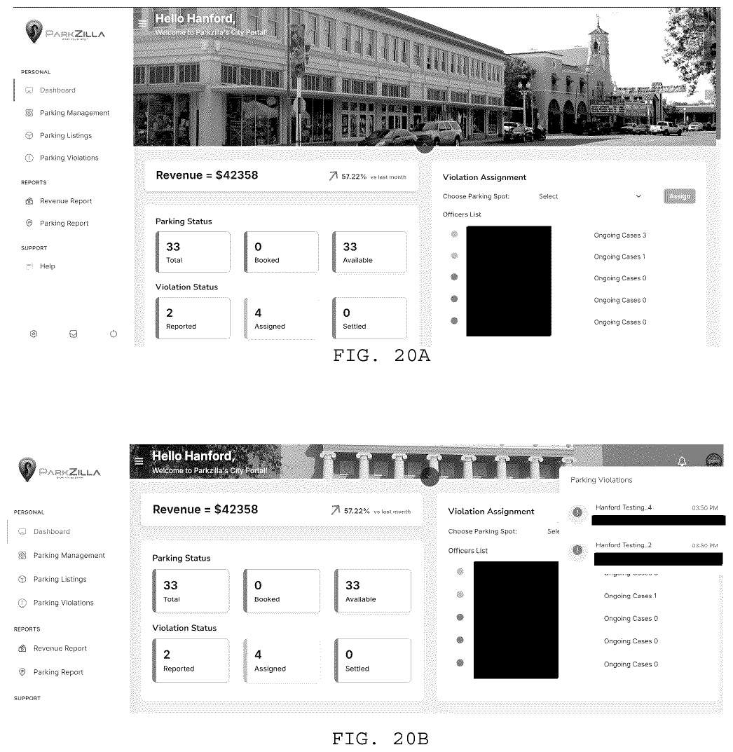

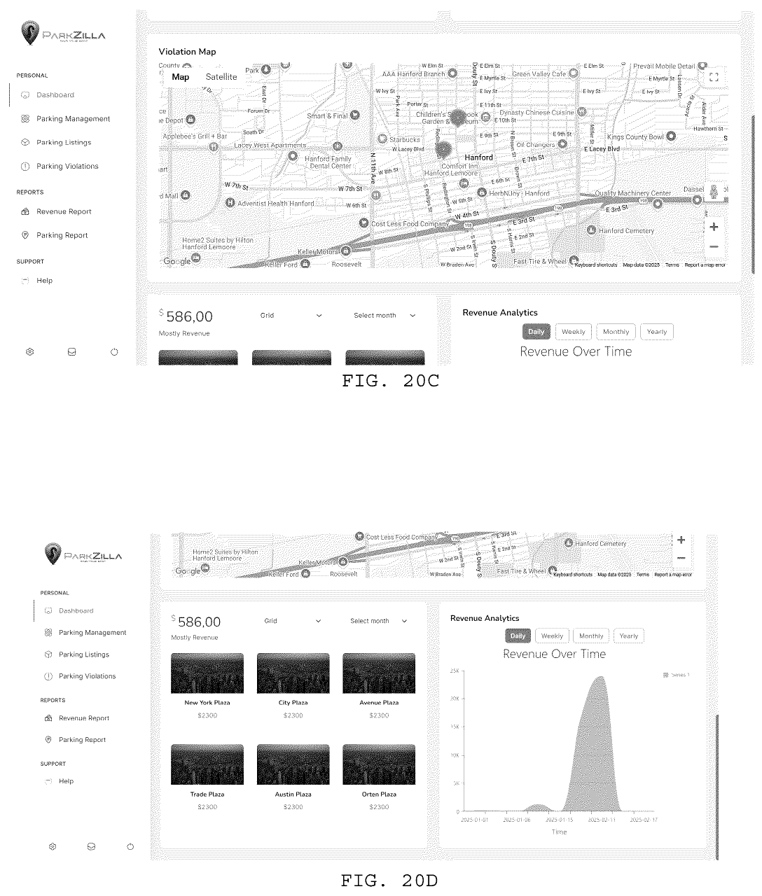

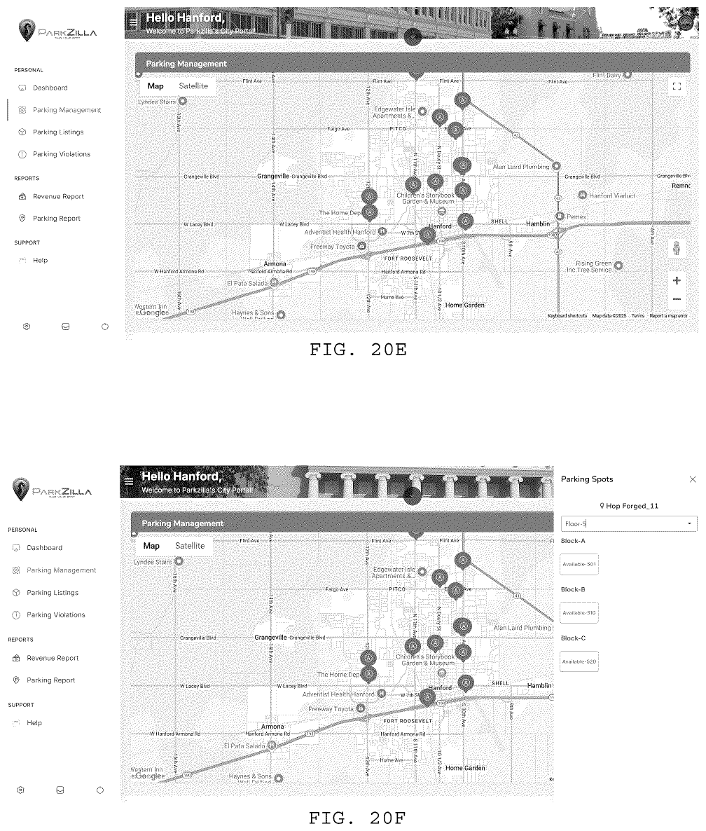

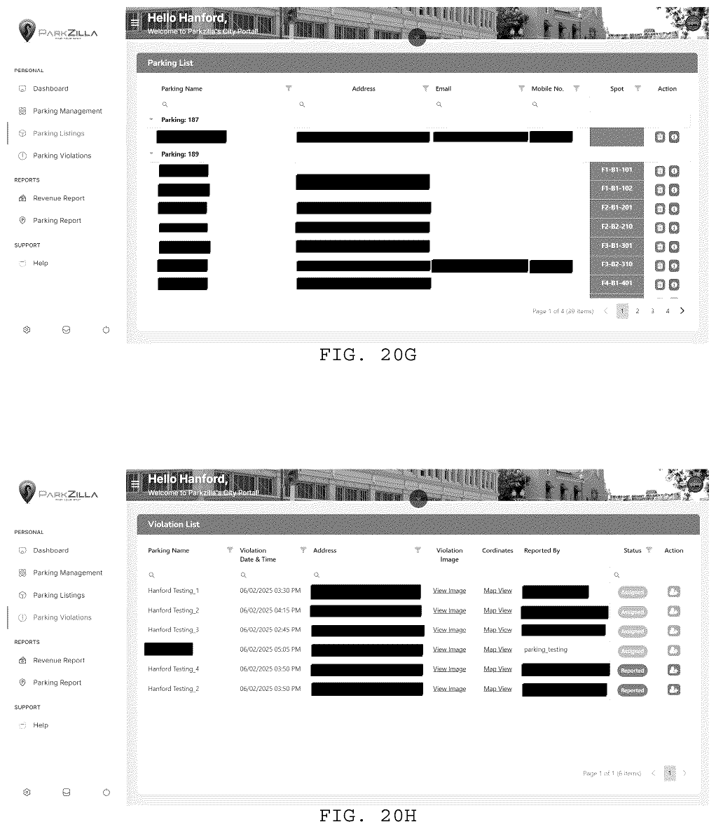

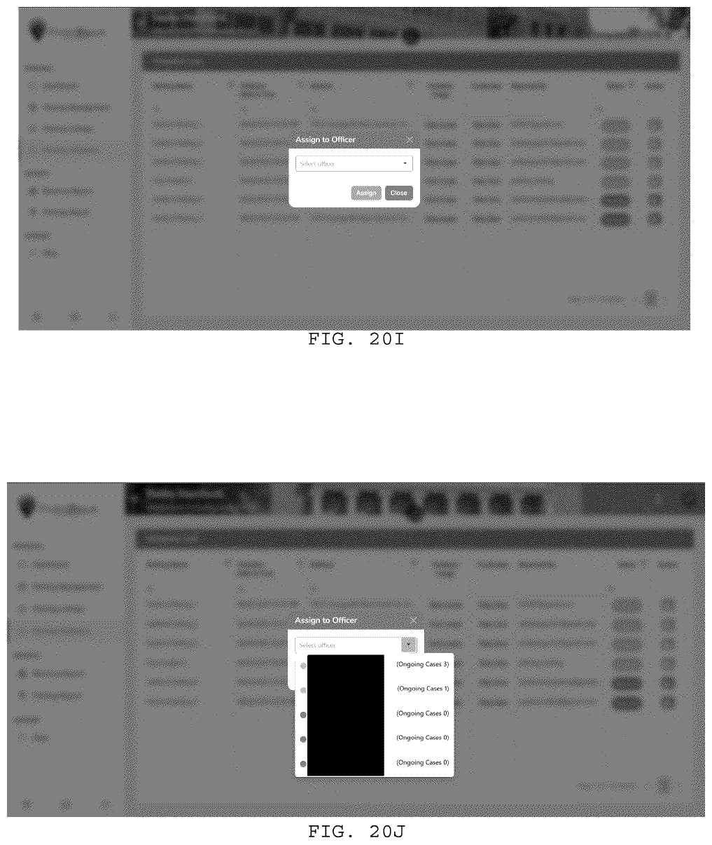

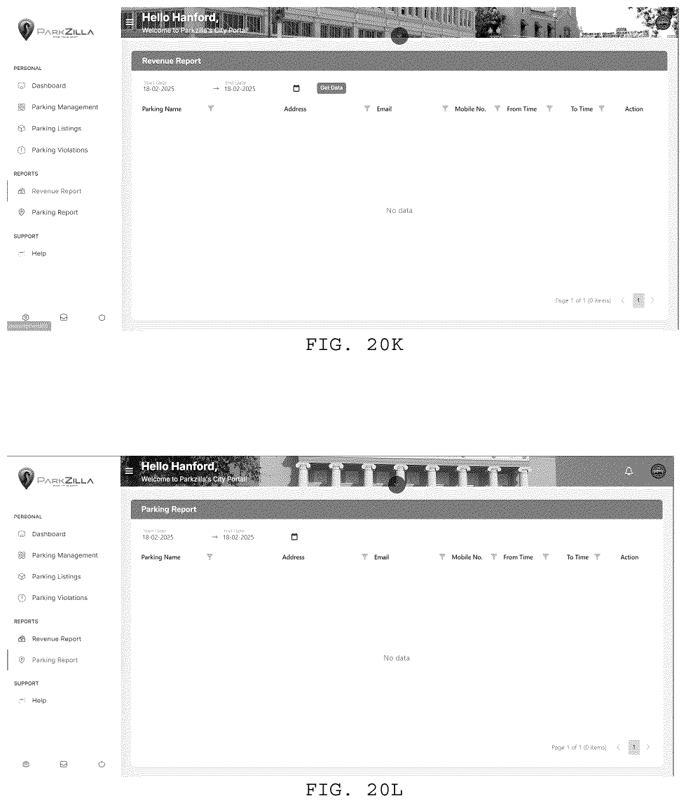

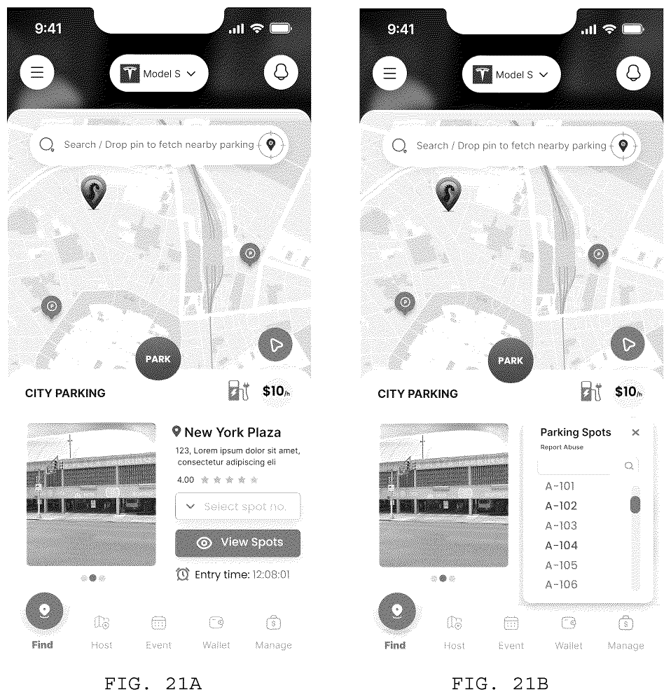

According to some embodiments, the parking management system may comprise a plurality of modules providing tools, data, and analytics related to parking management. For example, and with reference, generally, to FIGS. 20A-M, a parking management system may include a dashboard, parking management, parking listings, parking violations, revenue report, and parking report modules. In some embodiments, a dashboard may provide an overview or snapshot of data from other modules, such as revenue, statuses of parking listings and parking violations, parking alerts, and parking maps (see, e.g., FIGS. 20A-20D).

In accordance with some embodiments, a parking management module may provide a user with the ability to view and manage parking locations within a given area (e.g., a city). For example, and with reference to FIG. 20E, a user may be able to view parking locations on a map, with an indication of the status (available or occupied) of each location provided to the user. In some embodiments, a user may be able to view the total occupancy of a parking location, which may be expressed, for example, as a number of occupied and available spaces, or as a percentage of the total number spaces which are available or occupied. From a map, a user may be able to select a parking location to view the statuses of parking spaces within the location, as shown, for example, in FIG. 20F.

According to some embodiments of the present invention, a parking listings module may provide a listing of parking locations and the parking spaces located therein. Within a parking listings module, a user may be able to view information related to parking locations and spaces. For example, as illustrated in FIG. 20G, a user may be able to view the name(s)/title(s) of parking locations and corresponding spaces, as well their physical addresses and any contact information associated therewith, such as an e-mail address and phone number. A parking listings module may also provide a unique identifier for each parking space, such as an alphanumeric code, as further shown, for example, in FIG. 20G.

In some embodiments of the present invention, a parking violations module may provide a listing of parking violations (e.g., for nonpayment of a parking space rental) and information related thereto. For example, and with reference to FIG. 20H, a parking violations module may list the name(s)/title(s) of the parking spaces within with violations have occurred, along with the date and time of violation, the parking location address, the specific location of the parking space (e.g., GPS coordinates), a photograph evidencing the violation, and contact information for the reporter of the violation. According to some embodiments, a parking violations module may also provide the status of a violation (e.g., reported, assigned, resolved, etc.). For example, and with further reference to FIG. 20H, a user may be able to see that a parking violation has been assigned to, and is being managed by, another user (which, in some embodiments, may be designated as an “officer”). If, for example, a parking violation has been reported, but is not yet being managed, a user may assign the violation to another user, as illustrated, for example, in FIGS. 201 and 20J. In some embodiments, a parking violations module may also provide information about the availability of a user to manage a parking violation. For example, and with further reference to FIG. 20J, a user may be able to view the number of active parking violations being handled by other users.

According to some embodiments of the present invention, a revenue report module may provide financial information related to parking locations and parking spaces. For example, a user may be able to generate a revenue report for one or more parking locations or spaces for a specific timeframe or since inception (see, e.g., FIG. 20K). Likewise, a parking report module may provide statistical information related to parking locations and parking spaces. For example, a user may be able to generate a parking report for one or more parking locations or spaces for a specific timeframe or since inception (see, e.g., FIG. 20L). A parking report may include information such as the number of parking space rentals and parking violations (which may be expressed as a running total or a rate (e.g., average number of rentals per day, for example), average occupancy, average parking time, peaking parking rental day(s)/time(s), etc.

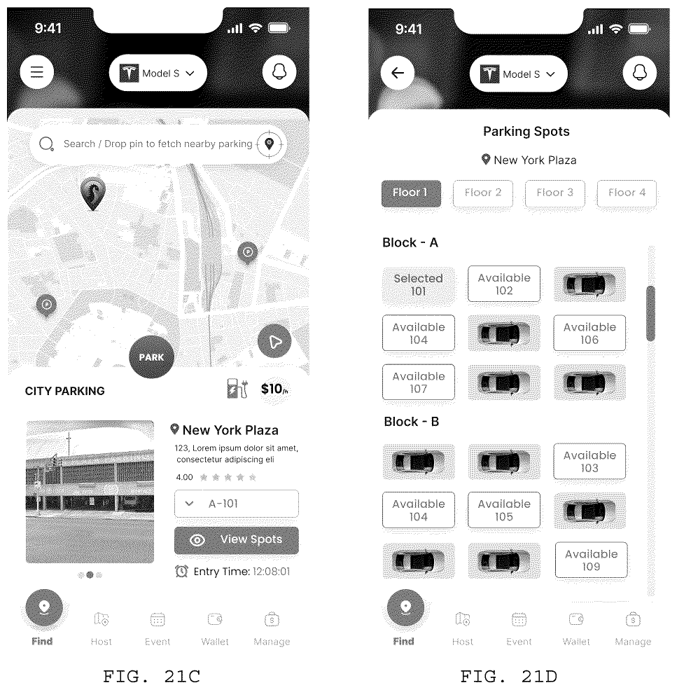

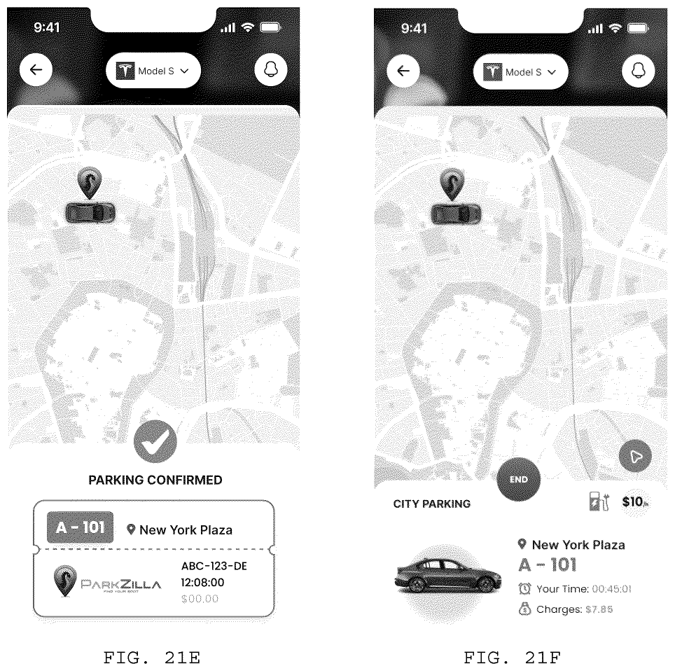

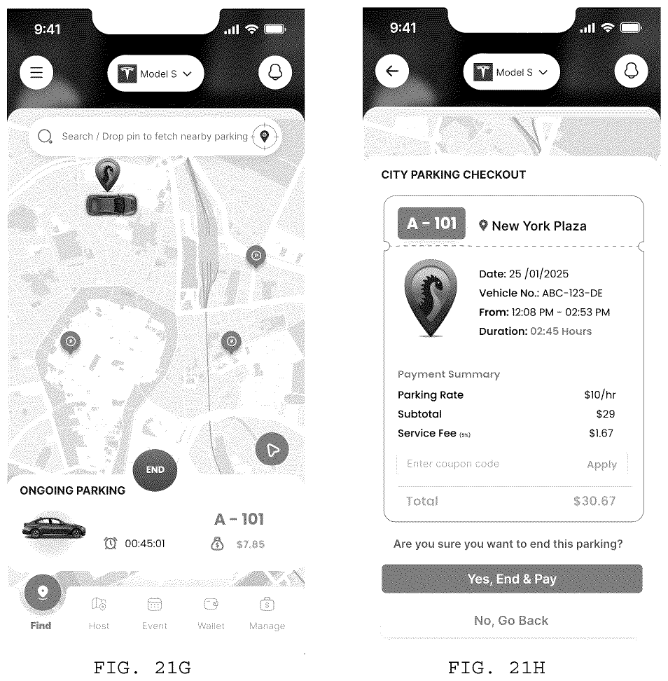

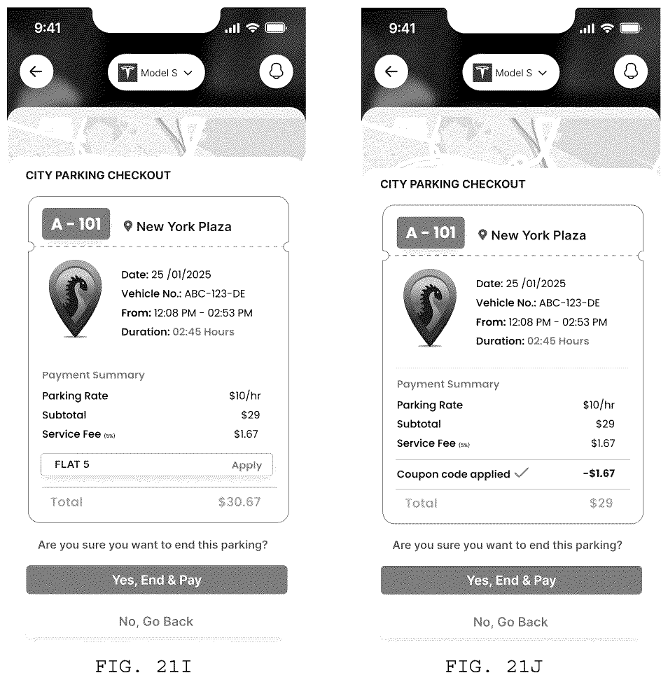

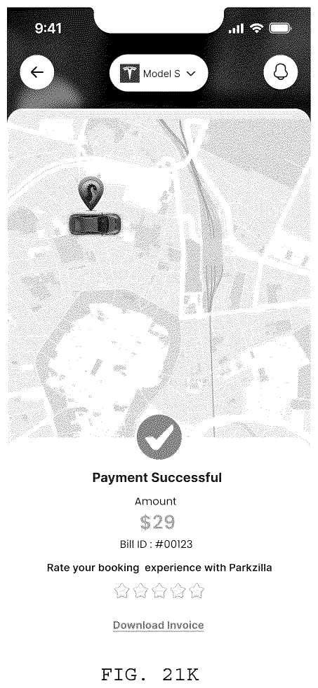

Reference is now made, generally, to FIGS. 21A-K, which are exemplary user interfaces illustrating features and functions related to the rental of a parking space. In some embodiments, a user may search for parking locations on a map integrated with the application. The map may show parking locations near the current location of the user (via the GPS location of the user's mobile device or vehicle, for example) or near a location set by the user (entered manually, or marked by the user on the map, for example), as illustrated in FIG. 21A, for example. The user may also be able to view parking locations within a desired area as a list. According to some embodiments, the user may set certain parameters for the search, such as, but not limited to, charging availability, desired start time, and/or parking rate. The user may also be able to view photographs of a parking location, as well as information about the same, such as, but not limited to, the parking location address (or an approximate location), parking rate(s), charger availability, user ratings, and operating hours.

According to some embodiments, and with reference to FIG. 21B, for example, when the user selects a parking location, they may be able to view all of the parking spaces within the selected location (which may include both available and occupied parking spaces) and select a parking space, as illustrated in FIG. 21C, for example. In some embodiments, the user may also be able to view the parking rate for the specific parking space and whether the parking space includes a charging station (if, for example, parking rates and charger availability are variable within a parking location). According to some embodiments, the user may be able to view a layout of parking spaces corresponding to the approximate physical arrangement of the parking spaces within the parking location. For example, and with reference to FIG. 21D, the user may be able to view different blocks of parking spaces, as well as which level the parking spaces are on (if the parking location has multiple levels).

According to some embodiments, if a user is not near their desired parking location, the user may be able to view parking spaces within the parking location, but cannot reserve a parking space until the user is within a specified distance from the parking location or parking space. In this case, the user may choose to select a parking space and then drive to the parking location. Once the user has parked their vehicle in the selected parking space (or once they are within the specified distance therefrom), the user may be able to confirm their rental. Alternatively, the user may first enter the parking location and then view and select a parking space, which may be available immediately for rental.

Once a parking space is selected and the rental thereof is confirmed, a timer may start and will continue to run until the user decides to end the rental, as illustrated, for example, in FIGS. 21E and 21F. During an active rental, the user may be able view the active timer and the real-time cost of the rental based on the parking rate (which, in some embodiments, may also include any additional fees to be charged upon ending the rental), as shown, for example, in FIGS. 21F and 21G. Once the user is ready to leave the parking space, they may end the rental and pay. For example, and with reference to FIGS. 21G and 21H, if the user is ready to end their rental, they may select “END”, which may then prompt the user to confirm ending their rental. Before confirming, the user may be provided with the total cost of the rental, including any additional fees. In some embodiments, the user may be able to provide a discount code, such as a coupon or promotional code, or a gift card or certificate number, as further illustrated, for example, in FIGS. 211 and 21J. Upon payment of the rental, the user may be provided with proof of payment, such as an invoice and/or a unique payment ID number or code, as illustrated, for example, in FIG. 21K.

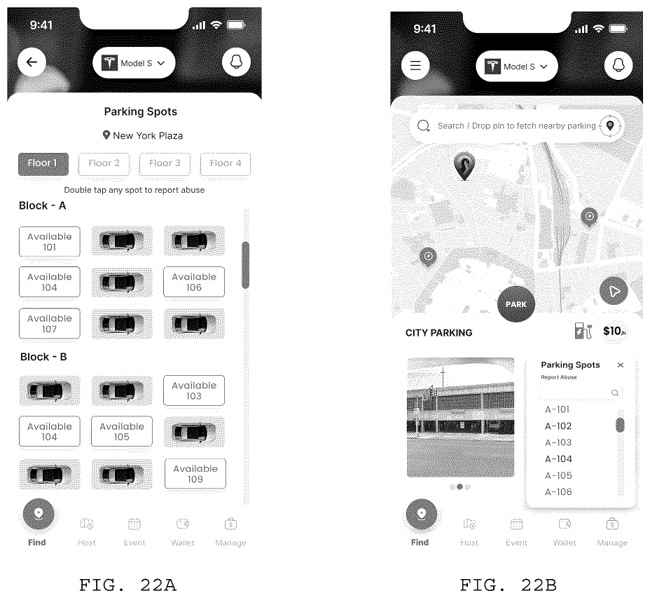

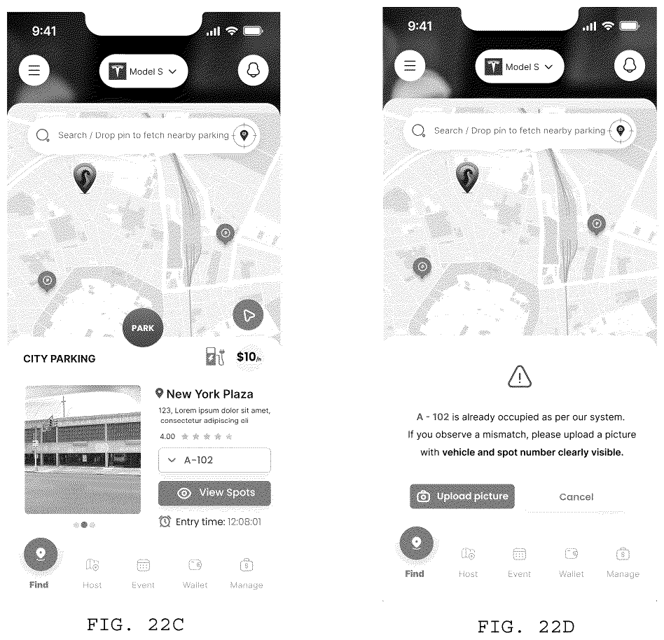

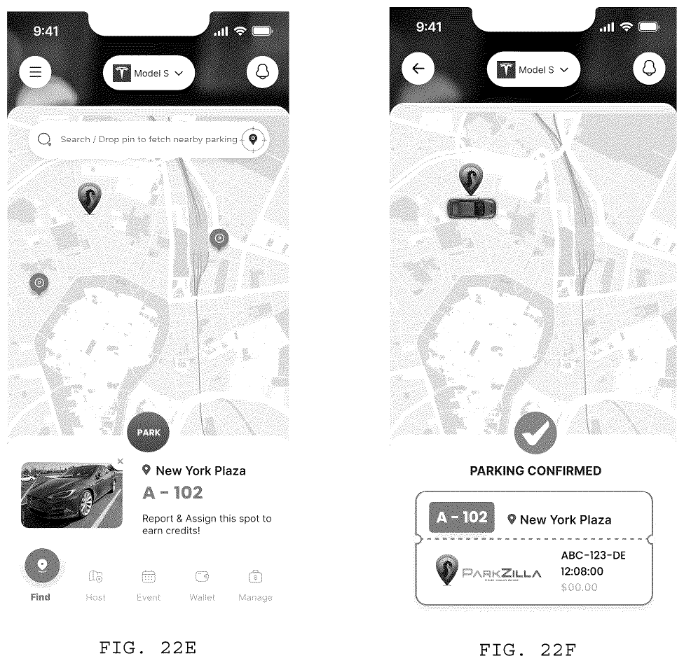

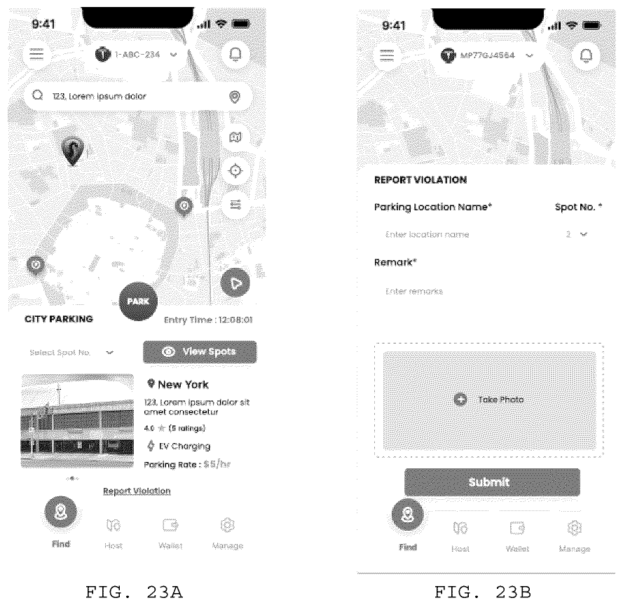

With reference now, generally, to FIGS. 22A-F, and in accordance with some embodiments, a user may be provided with an option to report when a reserved parking space is visually identified as available by the user. For example, and with reference to FIGS. 22A-C, a user may select a reserved parking space that has been visually confirmed as available by the user and report the misidentification. Upon doing so, in some embodiments, the user may be able to upload a photograph showing the space and the user's vehicle, as illustrated, for example, in FIGS. 22D and 22E. Once the misidentification has been resolved, the user may proceed to confirm the rental of the parking space, as illustrated, for example, in FIG. 22F.

Referring, generally, to FIGS. 23A and 23B, and according to some embodiments of the present invention, a user may be able to report a suspected parking violation. For example, if a user visually identifies an occupied parking space that is available for rental, they may report the violation. Likewise, if a user reserves a parking space, but visually identifies that the space is occupied by another party, the user may be able to report the violation. If a violation is suspected, a user may be able to select an option to report the violation, and then enter and submit information related to the violation, such as the parking location and space, remarks about the violation, and photographic evidence of the violation, as illustrated, for example, in FIGS. 23A and 23B. By reporting a parking violation, an owner may be able to take action to resolve the issue. For example, in response to a report of a parking violation, a municipality may send police or a parking enforcement officer to the location of the violation. In the event that a parking violation has occurred on private property, such as a private residence, the owner or property manager may request towing services to remove the vehicle in violation.

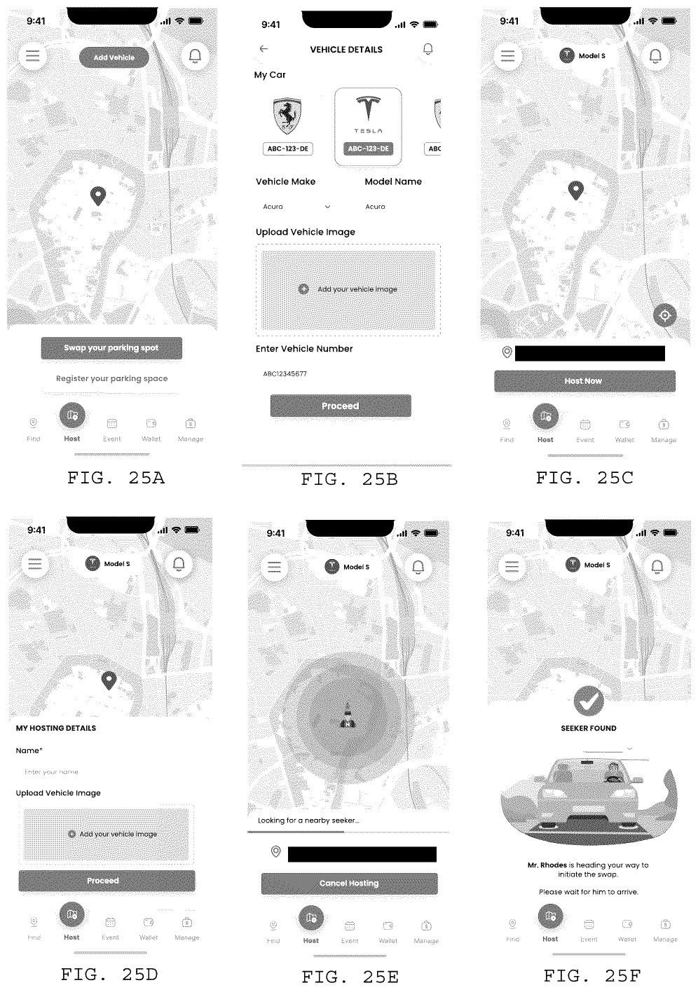

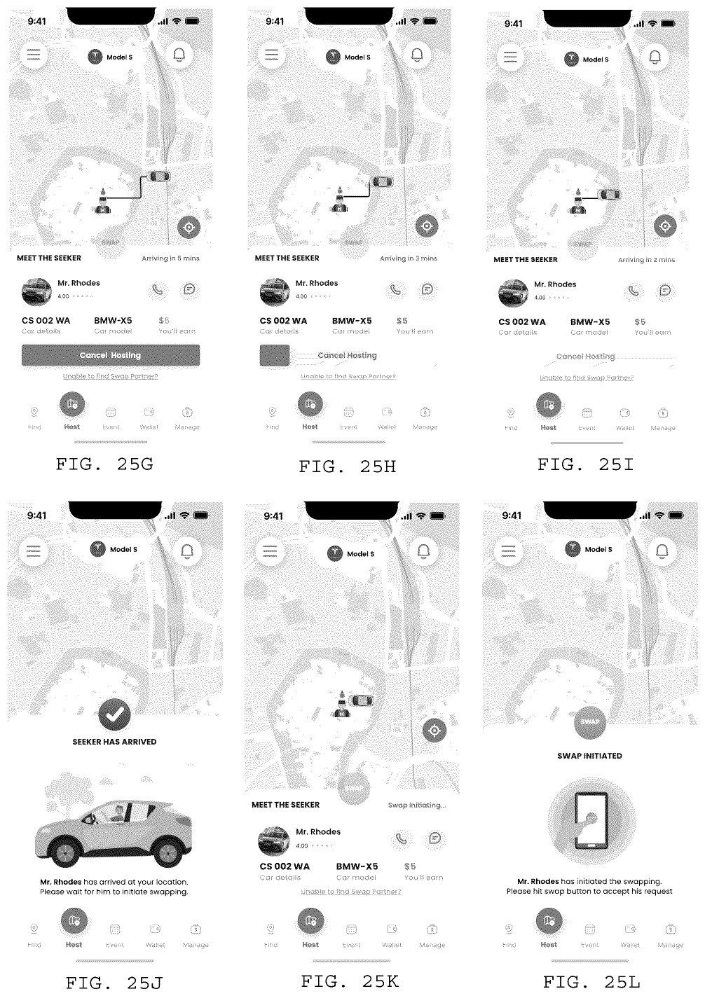

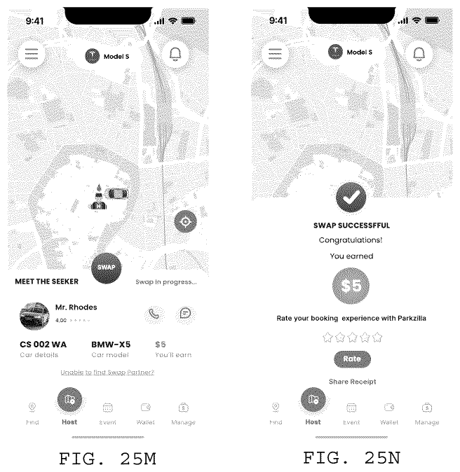

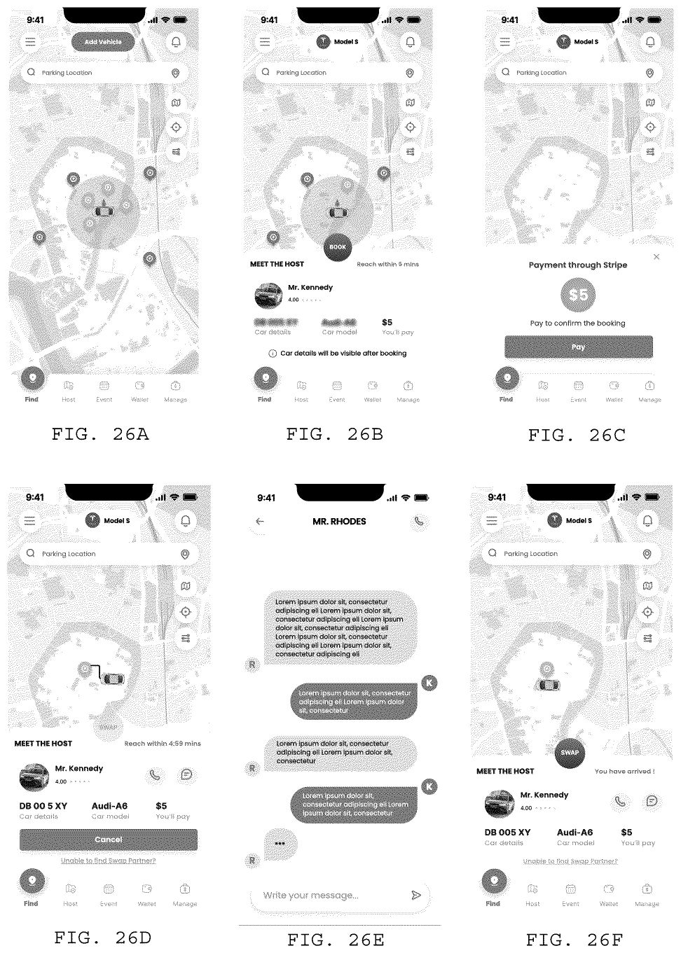

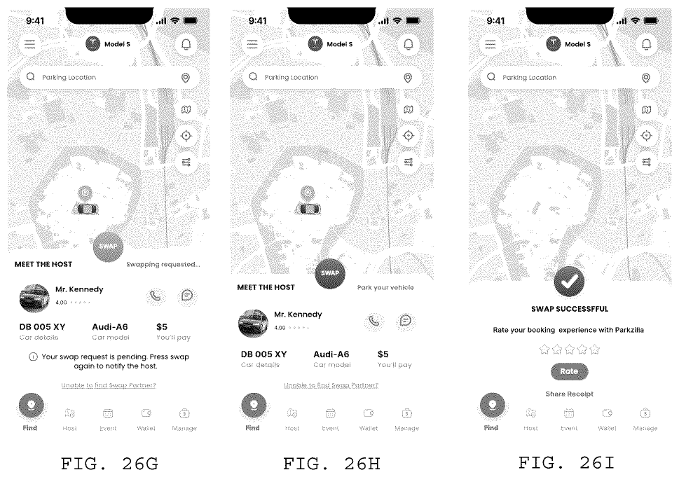

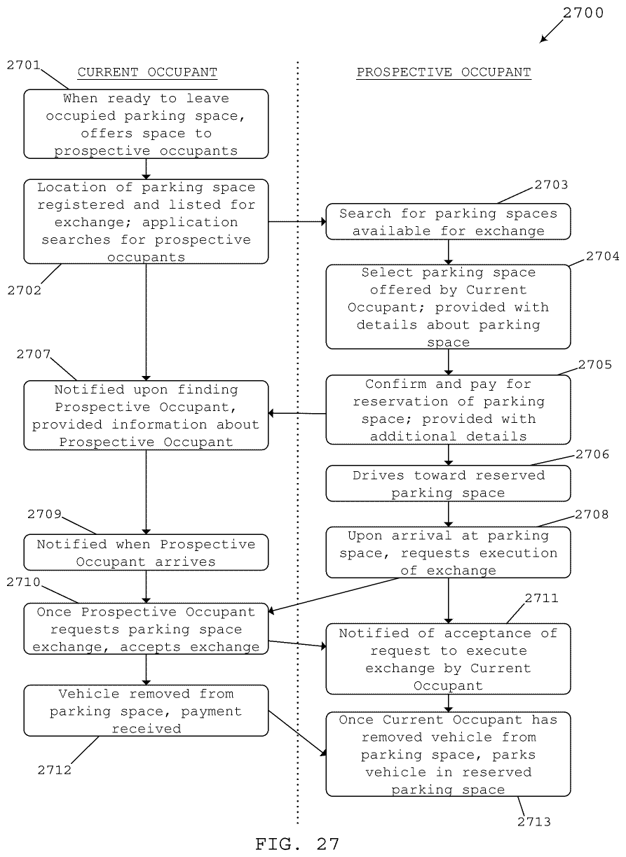

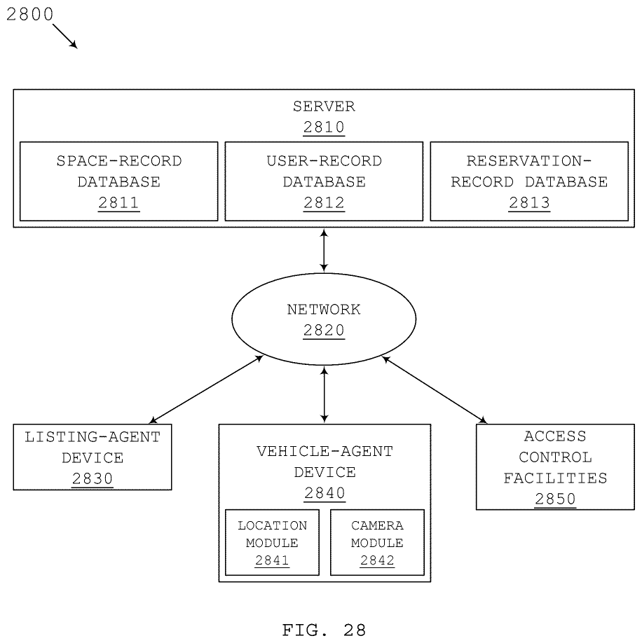

Reference is now made, generally, to FIGS. 25A-N and FIGS. 26A-I which illustrate exemplary user interfaces for a first user (which may be referred to as a “host”) occupying a parking space and a second user (which may be referred to as a “seeker”) looking to reserve the parking space, respectively. According to some embodiments of the present invention, a user who is actively occupying a parking space may be provided with an option to exchange their parking space (in some embodiments, for a fee) with second user who may be searching for a parking space within the nearby area. For example, and with reference to FIG. 25A, the first user may be provided with options to register and exchange their parking space. To register their parking space, the first user may provide information about their vehicle and/or parking space. For example, and with reference to FIG. 25B, the first user may provide their vehicle's make, model, and plate number, along with a photograph of their vehicle. The first user may also provide the address of the parking space (see, e.g., FIG. 25C) by entering the address manually or identifying the location on a map (e.g., by “dropping” a pin), or, alternatively, the location of the parking space may be determined by the GPS location of the first user's mobile device or vehicle. When the first user is ready to offer their parking space for exchange (and have provided the necessary information), they may select an option to make the space available, as illustrated, for example, in FIG. 25C. According to some embodiments, the first user may be required to provide additional details about the parking space and/or the user before being able to offer their parking space for exchange, such as a photograph of their vehicle in the parking space and the name of the user, as illustrated, for example, in FIG. 25D.

Once the first user has made the parking space available, the application may search for other users looking to reserve a parking space within the area (which may radial distance set by default or by a user searching for a parking space, for example), as illustrated, for example, in FIG. 25E. Before a user reserves the parking space, the first user may be provided an option to cancel the search and revoke the availability of the parking space for exchange, as further illustrated in FIG. 25E, for example. Once a second user confirms a reservation of the parking space, the first user may be notified and instructed to await the arrival of the second user, as illustrated in FIG. 25F. Upon confirmation, the first user may be provided information about the second user, such as, but not limited to, their name, vehicle information (e.g., make, model, plate number), phone number, and distance and/or time to the parking space. Such information may also be provided to the first user while they await the arrival of the second user, as illustrated, for example, in FIGS. 25G-I. As further illustrated in FIGS. 25G-I, the first user may be provided an option to cancel the reservation of the parking space which, in some embodiments, may be limited by time and/or distance (for example, the first user may only be able to cancel the reservation within a given amount of time).

Once the second user has arrived at the parking space, the first user may be notified and may be required to wait for the second user to initiate a request to exchange, as illustrated, for example, in FIGS. 25J-L. Once the second user has initiated the request (see, e.g., FIG. 25L), the first user may be provided with an option to accept the request, which may begin the exchange process, as illustrated in FIG. 25M, for example. When the exchange has been completed (e.g., once the first user has removed their vehicle from the parking space and/or the second user has parked their vehicle in the parking space), payment to the first user may be facilitated.

Further to the above, and with reference to the interfaces for the second user, the second user (as referred to above) may search for parking spaces which are available for exchange by other users (such as the first user referred to above), as illustrated, for example, in FIG. 26A. In some embodiments, the second user may provide the location of their desired parking space (by entering the address, or identifying the address on a map), or the location may be provided by the GPS location of the second user's mobile device or vehicle. The radial distance of the area to be searched may be, according to some embodiments, fixed by the application or the user may define the radial distance. From the one or more available parking spaces presented to the second user, an available parking space may be selected and the second user may be able to view details about the parking space, such as, but not limited to, the parking space address (exact or approximate), the name of the user currently occupying the space (in this example, the first user), the vehicle details of the user occupying the space, and the amount to reserve the parking space, as illustrated, for example, in FIG. 26B. Once the second user is ready to reserve the selected parking space, the second user may select an option to reserve the parking space and confirm the reservation by making payment (see, e.g., FIGS. 26B and 26C).

Once the parking space has been reserved, the second user may be provided instructions to meet the first user, as illustrated in FIG. 26D, for example. In some embodiments, once the parking space is reserved, the second user may be provided with additional information about the first user (which may not have been available previously), such as, but not limited to, the name of the first user, their vehicle information (e.g., make, model, license plate), and/or their contact information, as further illustrated, for example, in FIG. 26D. In some embodiments, the application may be configured for voice and/or text communication between the first user and the second user. For example, a voice call may be initiated within the application, or the first user and the second user may exchange text messages within the application, as illustrated, for example, in FIG. 26E. In some embodiments, communication features of the application may allow users to communicate without disclosing contact information (e.g., phone numbers).

When the second user arrives at the parking space (or is within a certain distance therefrom), they may be provided with an option to request initiation of exchanging the parking space, as illustrated, for example, in FIG. 26F. While the request is pending (i.e., awaiting acceptance by the first user), a status of the request may be provided to the second user and, in some embodiments, the second user may be provided with an option to re-send the request to the first user, as illustrated, for example, in FIG. 26G. Upon acceptance of the request by the first user, the second user may be notified (e.g., FIG. 26H) and may proceed to park their vehicle once the first user has removed their vehicle from the parking space. Upon completion of the exchange (which may be upon acceptance of the exchange request by the first user, upon removal of the vehicle of the first user from the parking space, or upon parking the vehicle of the second user in the parking space, for example), the second user may be notified, as illustrated in FIG. 26I, for example.

### Rental of Charging Stations

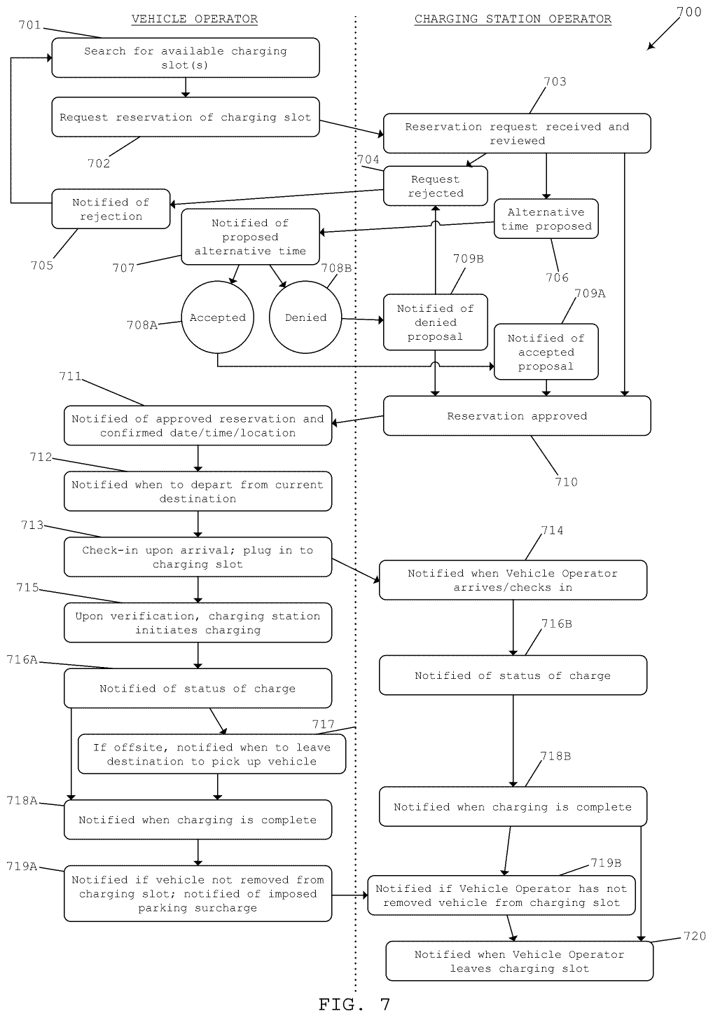

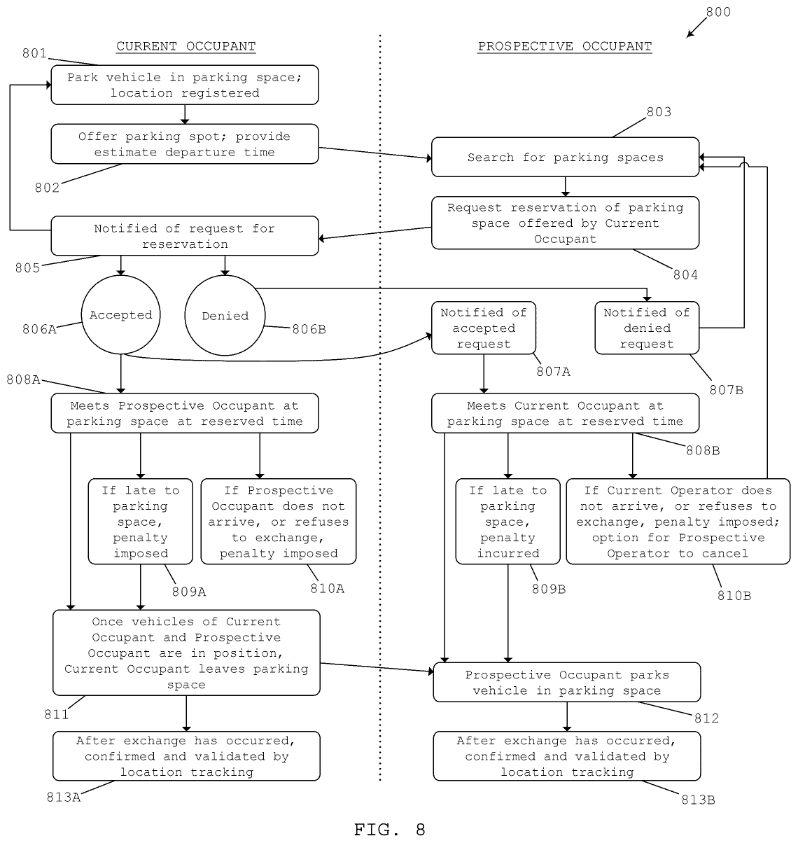

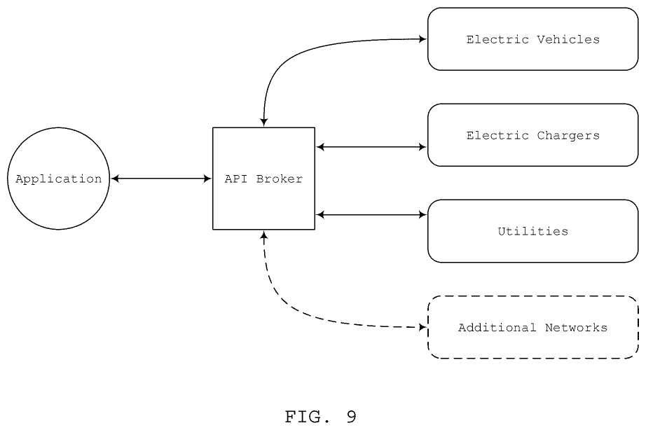

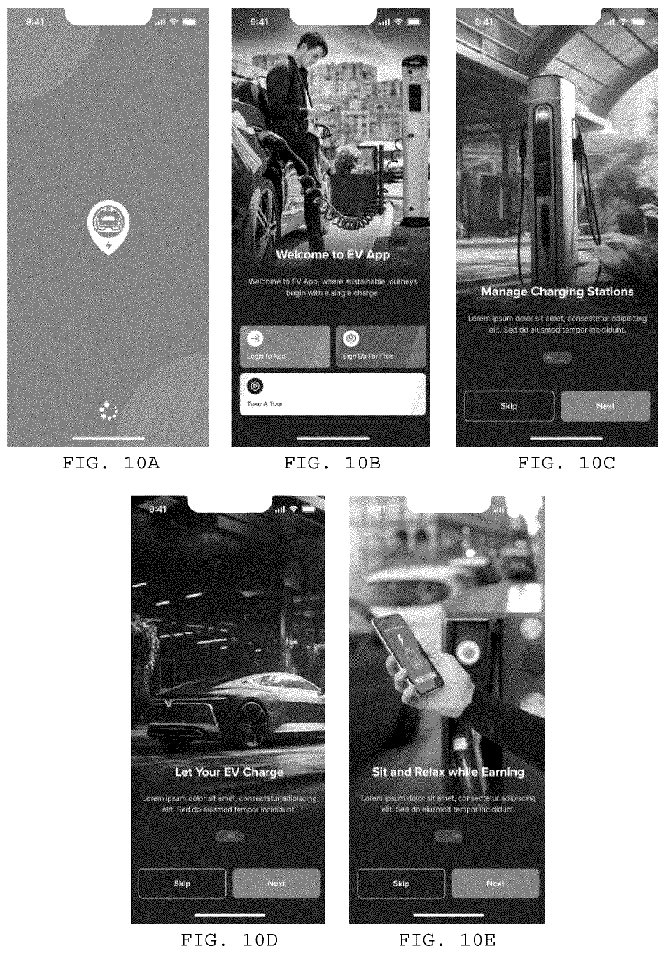

With reference to FIG. 7, an exemplary method 700 for coordinating the rental and use of an electric vehicle charger by a Vehicle Operator from a Charging Station Operator (hereafter, “Station Operator”) (or, in some embodiments, a station manager) may comprise a plurality of steps, which may be implemented via the application executing on a mobile device of the Vehicle Operator (hereafter, the “first mobile device”) and a mobile device of the Station Operator (hereafter, the “second mobile device”). Starting at Step 701, Vehicle Operator may perform a search for an available charging space. Next, and with reference to Step 702, Vehicle Operator may select, and request the rental of, a charging space (or multiple charging spaces). Following, and as indicated by Step 703, a notification may be sent to the second mobile device and Station Operator may receive and review the rental request. As one option, Station Operator may choose to approve the rental request, as indicated by Step 710.

Further to the above, as another option, Station Operator may choose to reject the rental request, as indicated by Step 704, which, in turn, may cause a notification to be sent to the first mobile device to notify Vehicle Operator that the rental request has been rejected, as indicated by Step 705. If the rental request is rejected, Vehicle Operator may have the option of starting a new search (i.e., return to Step 701) or wait for responses (acceptance or denial notification) from other station operator users (if Vehicle Operator placed multiple rental requests).

As another option following Step 703, Station Operator may propose one or more alternative rental times, as indicated by Step 706, which, in turn, may cause a notification to be sent to the first mobile device notifying Vehicle Operator that an alternative rental time(s) has been proposed, indicated by Step 707. If Vehicle Operator decides to accept the alternative rental time (or one of the alternative times), as indicated by Step 708A, a notification may be sent to the second mobile device notifying Station Operator that the alternative time has been accepted, indicated by Step 709A. Following Step 709A, Station Operator may approve the rental request (with the alternative rental time), as indicated by Step 710.

Further to the above, and referring back to Step 707, if Vehicle Operator decides to deny the alternative rental time, as indicated by Step 709B, a notification may be sent to the second mobile device notifying Station Operator that the alternative time has been denied, indicated by Step 709B. Following Step 709B, Station Operator may reject the rental request, reverting to Step 704 (and then Step 705). Alternatively, Station Operator may decide to approve the rental request (with the original rental time), as indicated by Step 710.

After the rental request has been approved (Step 710), a notification may be sent to the first mobile device notifying Vehicle Operator that the rental request has been approved and providing the confirmed date and time of the rental and the location of the charging station with the reserved space, as indicated by Step 711. Optionally, prior to the rental time, a notification may be sent to the first mobile device notifying Vehicle Operator that it is time for Vehicle Operator to depart from their current location, indicated by Step 712 (in this case, the location of Vehicle Operator may be tracked by the GPS location of the first mobile device or the vehicle). Next, with reference to Step 713, upon arrival at the charging space, Vehicle Operator may plug their vehicle into the charger. Following, a notification may be sent to the second mobile device notifying Station Operator that Vehicle Operator has arrived and/or checked in at the charging space, as indicated by Step 714. Once the vehicle and Vehicle Operator have been verified, the charger may initiate charging of the vehicle (by means of an API with the charger network), as indicated by Step 715.

While the vehicle is charging, notifications may be sent to both the first and second mobile devices notifying Vehicle Operator and Station Operator of the live status of the charge, as indicated by Steps 716A and 716B, respectively. Optionally, and with reference to Step 717, in the event that Vehicle Operator is not with their vehicle during charging, a notification may be sent to the first mobile device notifying Vehicle Operator when it is time for them to depart from their current location in order to arrive back at the charging space by the time charging is complete. Once charging is complete, notifications may be sent to both the first and second mobile devices notifying Vehicle Operator and Station Operator of the same, as indicated by Steps 718A and 718B, respectively. Optionally, in the event that the vehicle is not removed from the charging space within a specified time period following the scheduled rental time or following the time that charging was completed, a notification may be sent to the first mobile device notifying Vehicle Operator of the same and a notification may also be sent to the first mobile device notifying Vehicle Operator of a resulting parking surcharge, as indicated by Step 719A. At or about the same time, a notification may be sent to the second mobile device notifying Station Operator that Vehicle Operator has not removed their vehicle from the charging space, as indicated by Step 719B. Lastly, and with reference to Step 720, a notification may be sent to the second mobile device notifying Station Operator once Vehicle Operator removes their vehicle from the charging space.

### Rental of Parking Spaces

It is to be appreciated that the method described above can be modified to be implemented for coordinating the rental and use of a parking space by a vehicle operator user from a station operator user. For example, Steps 700-720 would be substantially unchanged, with some exceptions. In Step 713, Vehicle Operator would not plug into a charger, since they have only reserved a parking space. Likewise, in Step 715, upon verification, charging would not initiate; however, a timer may start to track the amount of time the vehicle is in the parking space. Furthermore, in Steps 716A and 716B, Vehicle Operator and Station Operator may be notified of the status of the vehicle in the charging space (e.g., time elapsed, whether a request for additional time has been made), rather than the charge. Similarly, in Steps 718A and 718B, Vehicle Operator and Station Operator may be notified when the amount of time that was reserved has expired or when a certain time is reached. In Steps 719A and 719B, Vehicle Operator and Station Operator may be notified if the vehicle is not removed from the parking space within a specified time period following the scheduled rental time and Vehicle Operator may also be notified of a resulting parking surcharge. Lastly, in Step 720, Station Operator would be notified once the vehicle is removed from the parking space, rather than the charging space.

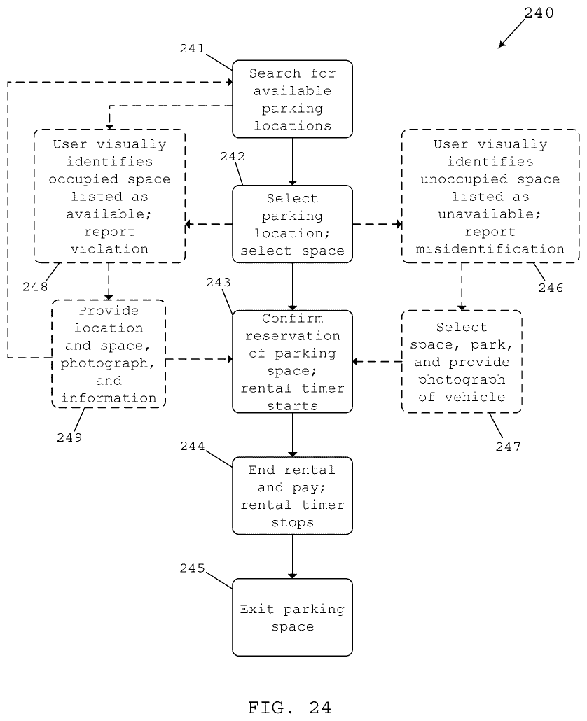

With reference now to FIG. 24, another exemplary method 240, which may be implemented via the application, for renting a parking space is illustrated. First, according to Step 241, a user may search for available parking locations (which may have one or more parking spaces) in a desired area. Next, according to Step 242, the user may select a parking location which may then provide the user with available parking spaces (and, in some embodiments, occupied parking spaces) within the parking location and the user may select a parking space to rent (which, in some embodiments, may allow the user to view details about the parking space). Following, in Step 243, the user may reserve the parking space, which will start a timer to track the amount of time the user occupies the parking space. Once the user is ready to leave the parking space, in Step 244, the user may end the rental, stopping the timer, and pay for the rental (based at least in part on the amount time the user occupied the space). Lastly, and according to Step 245, once the user has successfully paid for the rental of the parking space, they may exit the parking space.

With further reference to FIG. 24, in the event that a user visually identifies an unoccupied parking space within a parking location that they would like to reserve, but which has been incorrectly identified within the application as unavailable, the user may report the misidentification, in accordance with Step 246. Once the misidentification has been reported, in Step 247, in order to verify the availability of the desired misidentified parking space and reserve it, the user may select the parking space, park their vehicle in the parking space, and provide a photograph of their vehicle parked in the selected parking space. Upon verification of availability, the user may then proceed to confirm the rental of the parking space and start the rental, in accordance with Step 243.

With additional reference to FIG. 24, in the event that a user visually identifies an occupied parking space that is currently listed as available, the user may report the parking violation, in accordance with Step 248. To report the violation, the user may provide the parking location, the parking space, a photograph showing the violation, and/or any additional information or remarks, in accordance with Step 249. In some embodiments, a user may be able to report a parking violation without having to reserve a parking space or be in the process of doing so. A user may also, according to some embodiments, be able to report a parking violation while searching for, or reserving, a parking space. For example, a user may be searching for available parking locations (e.g., Step 241) when they discover a parking violation. In some cases, a user may discover a violation occurring within their selected (but not yet confirmed) parking space, in which case the user may report the violation and then restart their search for a new parking location/space (e.g., Step 241 or Step 242).

### Parking Space Exchange

An exemplary method 800, which may be implemented via the application, for coordinating an exchange of a parking space from a current occupant thereof (the Current Occupant) to a prospective occupant of the parking space may comprise a plurality of steps, as illustrated in FIG. 8. First, starting at Step 801, the Current Occupant may park their vehicle in a parking space and provide a location (exact or approximate) thereof. Next, and referring to Step 802, the Current Occupant may offer the parking space to one more prospective occupants, providing an estimated time of departure. Next, a prospective occupant (the Prospective Occupant) may search for parking spaces for a specified area and/or time, where the search yields an option to reserve the parking space offered by the Current Occupant, as indicated by Step 803. Following, the Prospective Occupant may request the rental of the parking space offered by the Current Occupant (and, optionally, other parking spaces), as indicated by Step 804. After the Prospective Occupant has made the rental request, the Current Occupant may be notified of the request, as indicated by Step 805.

Following Step 805, if the Current Occupant accepts the rental request, indicated by Step 806A, the Prospective Occupant may be notified of the accepted rental request and may be provided with the confirmed date and time of the rental and the location of the parking space. Alternatively, if the Current Occupant denies the rental request, indicated by Step 806B, the Prospective Occupant may be notified of the denied rental request and may revert to Step 803 to search for another parking space (or wait for a response from another vehicle operator).

Following Steps 806A and 807A, the Current Occupant may meet the Prospective Occupant at the reserved time, and the Prospective Occupant may meet the Current Occupant at the reserved time, as indicated by Steps 808A and 808B, respectively. In some cases, if the Current Occupant is late to the parking space, a penalty may be imposed, as indicated by Step 809A. Likewise, if the Prospective Occupant is late to the parking space, a penalty may be imposed, as indicated by Step 809B. In other cases, if the Current Occupant does not meet at the parking space after a specified period of time, or otherwise refuses to accept the parking space, a penalty may be imposed, as indicated by Step 810A. Likewise, if the Prospective Occupant does not meet at the parking space after a specified period of time, or otherwise refuses to leave the parking space, a penalty may be imposed and/or the Current Occupant may be provided an option to cancel the rental, as indicated by Step 810B.

Following steps 808A or 809A, once the vehicle of the Current Occupant and a vehicle of the Prospective Occupant are in a position to exchange, the Current Occupant my remove their vehicle from the parking space, as indicated by Step 811. Next, after the vehicle of the Current Occupant is removed from the parking space, the Prospective Occupant may move their vehicle into the parking space, as indicated in Step 812. Once the exchange has been completed, it may be confirmed by the Current Occupant and validated by the location of their vehicle, as indicated by Step 813A. At about the same time, once the exchange has been completed, it may be confirmed by the Prospective Occupant and validated by the location of their vehicle, as indicated by Step 813B.

With reference now to FIG. 27, another exemplary method 2700, which may be implemented via the application, for coordinating an exchange of a parking space from a current occupant thereof (hereafter the “Current Occupant”) to a prospective occupant of the parking space is illustrated. First, according to Step 2701, when the Current Occupant is ready to leave the parking space they are currently occupying, they may offer the parking space to one or more prospective occupants. Next, and according to Step 2702, the location of the parking space (which, in some embodiments, may be determined automatically or manually provided) may be registered and listed as available for exchange by a prospective occupant, and the application may begin to search for a prospective occupant. Once the parking space is made available, in Step 2703, a prospective occupant (hereafter the “Prospective Occupant”) may search for, and view a list of, available parking spaces near their location, which may include the parking space currently occupied by the Current Occupant. In Step 2704, the Prospective Occupant may select the parking space offered by the Current Occupant and may be provided with information related to the parking space and/or the Prospective Occupant (e.g., approximate or exact location of parking space, photograph of parking space, vehicle make and model, photograph of vehicle, etc.). Next, according to Step 2705, the Prospective Occupant may confirm, and pay for, a reservation of the parking space and, upon doing so, may be provided with additional information related to the parking space and/or the Current Occupant (which may include any of the aforementioned details). After the Prospective Occupant has confirmed the reservation, and according to Step 2706, the Prospective Occupant may begin driving toward the reserved parking space. Also after confirmation of the reservation, and according to Step 2707, the Current Occupant may be notified about the reservation and may be provided with information about the Prospective Occupant.

With continued reference to FIG. 27, once the Prospective Occupant arrives at the parking space, they may request to execute the exchange of the parking space, according to Step 2708. Upon arrival of the Prospective Occupant, and according to Step 2709, the Current Occupant may be notified (and can prepare to exit the parking space). Once the Prospective Occupant has made the exchange request, the Current Occupant may accept the request, according to Step 2710, and the Prospective Occupant may be notified of the accepted request, according to Step 2711. According to Step 2712, once the Current Occupant has accepted the exchange request, they may remove their vehicle from the parking space and receive payment for the exchange. Once the Current Occupant has removed the vehicle from the parking space, the Prospective Occupant may park their vehicle in the reserved parking space, according to Step 2713.

### API Integration

According to some embodiments of the present invention, the application may be operatively connected to a plurality of networks, such as vehicle networks, charger networks, and utility (e.g., solar or electricity) networks, via one more APIs. In some embodiments, the application may interface with an API broker which may be operatively connected to a plurality of networks, as illustrated, for example, in FIG. 9. By this established connection, the application may, in some embodiments, be able to retrieve data from registered chargers (or those to be registered) as well as control (i.e., start and stop) the chargers and retrieve their status information. Furthermore, and according to some embodiments, the application may be able to retrieve data from an electric vehicle, such as the level of charge that the vehicle's battery currently holds. In addition, the application may be able to, in some embodiments, retrieve data from a utility company, such as electricity rates. According to some embodiments, the application may be able to retrieve data from a solar panel controller, such as solar power production.

According to some embodiments of the present invention, a system for implementing the above methods and processes may include a remote server which may maintain a plurality of databases. For example, and with reference to FIG. 28, a system 2800 may include a server 2810 operatively connected to a network 2820 and comprising a processor, a memory, and a storage element having a space-record database 2811, a user-record database 2812, and a reservation-record database 2813. A space-record database may store a plurality of space records comprising information related to parking spaces (with or without chargers), such as, but not limited to, location, availability status (i.e., “available”, “occupied”, or “temporarily withheld”), charging information, and rates. A user-record database may store a plurality of user records comprising information related to application users, such as, but not limited to, usernames, IDs, user roles, contacts, accessibility, and authorized payment information (e.g., pre-authorized bank and credit/debit card information). A reservation-record database may store a plurality of reservation records comprising information related to parking space reservations, such as, but not limited to, a space link (an association with a parking space), user link (an association with a user), status, elapsed time, and cost.

According to some embodiments, a system may comprise a listing-agent device (e.g., mobile device or computer) operatively connected to a remote server and configured to execute the application thereon by a user looking to list a parking space for reservation (e.g., homeowner, manager, operator, city/government official, officer, occupant of a current parking space, etc.). For example, and with further reference to FIG. 28, system 2800 may further include a listing-agent device 2830 operatively connected to server 2810 via network 2820. In some embodiments, a listing-agent device may be configured to create and modify parking space records. For example, a charging station owner may be able to create and modify a record for the charging station via the application operating on a mobile device.

In some embodiments of the present invention, a system may comprise a vehicle-agent mobile device operatively connected to a remote server and configured to execute the application thereon by a user looking to reserve a parking space. For example, and with further reference to FIG. 28, system 2800 may further include a vehicle-agent device 2840 operatively connected to server 2810 via network 2820. According to some embodiments, the application may interface with GPS and messaging capabilities and a camera of a vehicle-agent mobile device. For example, and as illustrated in FIG. 28, vehicle-agent device 2840 may comprise a location module 2841 and a camera module 2843 which may be able to determine a location of vehicle-agent device 2840 and obtain an image, respectively, and provide this data to server 2810.

According to some embodiments of the present invention, a server of a system may be configured to receive a listing update (from a listing agent, for example) and create a space record. A server may also be configured to receive a query regarding the availability of a parking space and provide candidates therefor (e.g., users searching for an available parking space). According to some embodiments, a server may also be configured to, upon confirming a reservation by a vehicle agent, create a reservation record and update the space record associated with the reserved parking space to indicate its availability status as “unavailable”. A server may be further configured to receive a start-verification (i.e., verification that the reservation has started) and, upon validating, start a reservation timer.

In accordance with some embodiments, when a discrepancy exists between a recorded availability status (e.g., “available”) and an observed status (e.g., visually observed to be unavailable) of a parking space, a vehicle agent (via a vehicle-agent mobile device) may provide information related to the discrepancy (which may be referred to as a “discrepancy package”), such as an image and/or geolocation of the parking space. In some embodiments, a server may be configured to compare the discrepancy information with database records (e.g., space and reservation records) and update the records accordingly. When a change in an availability status of a parking space occurs, a server may be configured to send a notification to the listing-agent device of the agent associated with the parking space (e.g., the user who listed the space or a user authorized to manage the space).

In some embodiments, in the event that the discrepancy information shows that a space is available, but the availability status of the space record is “unavailable”, a server may be configured to change the availability status of the space record to “temporarily withheld” and grant exclusive availability to the vehicle agent that reported the discrepancy. If the vehicle agent accepts the reservation of the parking space (for which there may be a time limit), the server may be configured to update the status of the parking space as unavailable. If the vehicle agent declines the reservation of the parking space (or the time limit expires), the server may be configured to update the status of the parking space as available.

In some embodiments, in the event that the discrepancy information shows that a space is unavailable, but the status of the space is recorded as available, the server may be configured to log the violation and send a notification (which may include an image and/or location) to a listing-agent device of the agent associated with the parking space. Upon receipt of the notification, the listing agent (or designated/authorized agent) provide verification of the violation to the server and the server may be configured to log confirmation of the violation. For example, if a parking violation has occurred, the server may be configured to send an alert to an enforcement-agent device (such as a mobile device of a parking officer) and the enforcement agent may capture and provide the geolocation and image of the violation.

According to some embodiments, if a violation has occurred, the server may be configured to determine if the violator is a registered user of the application. If the violator is a registered user, the server may be configured to send a notification to the mobile device of the violator notifying them of the violation and possible actions resulting therefrom. For example, the server may be configured to send a notification to the mobile device of the violator indicating that they must pay for unauthorized usage of the parking space (which may include a penalty charge). In some embodiments, the notification may include a warning that the violator's vehicle may be towed. The server may also, according to some embodiments, be configured to dispatch a towing service to tow the vehicle of a violator. For example, if the violator does not pay for unauthorized usage of the parking space and/or does not remove their vehicle from the space, the server may dispatch a pre-authorized towing service to tow the vehicle.

According to some embodiments of the present invention, a parking space record may comprise a maximum reservation duration (i.e., the maximum amount of time a user can reserve the space) and the server may be configured to track the amount of time a user has occupied a parking space and send a notification to a listing-agent device if the elapsed time exceeds the maximum reservation duration. For example, if a user has occupied a space for an amount of time that exceeds the maximum reservation duration, the server may send a notification to the device of a listing agent and apply a surcharge to the reservation. In some embodiments, a parking space record may have a rate change delay. For example, if a user has occupied a space for an amount of time that exceeds the maximum reservation duration, the server apply a surcharge to, or increase the parking rate of, the reservation after the rate change delay (i.e., after a given amount of time has passed).

In accordance with some embodiments, a space record may include information about charging capability and charging energy rates, and a reservation record may include information about charger usage. In some embodiments, the server may be configured to log data related to charger status. For example, the server may be configured to log power usage (kWh), charging cost rate, start/stop, and errors. According to some embodiments, the server may be configured to send charger status notifications to a vehicle-agent device and/or listing-agent device. In some embodiments, the server may be configured to calculate a charging cost. For example, when a vehicle agent has finished charging their vehicle, the server may calculate the charging cost using the charging cost rate and the total amount of energy consumed during the charge. In some embodiments, the server may be configured to add a fee (which may be a flat fee or time-based fee) and calculate a total cost (charging cost plus additional fees).

According to some embodiments of the present invention, a server may be configured to provide navigation assistance. For example, upon confirmation of a parking space reservation, the server may provide route data (navigational guidance to the parking space) to a vehicle-user mobile device. The vehicle-user mobile device may provide a map and navigational guidance, via the application, to a vehicle user who has reserved a parking space. In some embodiments, the vehicle-user mobile device may periodically provide its current geolocation to the server via the application.

In some embodiments of the present invention, a reservation may be closed or ended by verification of arrival at the reserved parking space. For example, the geolocation of a vehicle-agent mobile device and/or image of the parking space (showing that the space is occupied by the vehicle agent) may be used to verify arrival at the space by the vehicle agent. Upon verification of arrival, the server may be configured to end or close the reservation and, optionally, send a notification to the vehicle agent and/or listing agent. In some embodiments, the server may be configured to calculate a reservation cost and facilitate payments from the vehicle agent and to the listing agent, respectively. For example, upon the closure of a reservation, the server may calculate the total cost of the reservation and request payment in the amount of the total cost from the vehicle agent. At about the same time, or upon payment by the vehicle agent, the server may facilitate payment to the listing agent (which may be the total amount paid by the vehicle agent, or a portion thereof).

According to some embodiments, a space record may comprise an indicator which may identify whether a parking space has access control facilities, such as a gate or a garage. For example, a parking space may be directly or indirectly accessible via a gate (e.g., where the parking space is at a house with a gated driveway or the house is within a gated community). In some embodiments, the server may be configured to issue and send access credentials to a vehicle agent upon confirming a reservation or post-confirmation. For example, the server may provide a code (e.g., an alphanumeric code or QR code) which may be used to open a gate. As another example, the server may grant access to the gate via an RFID device (such as via the NFC capabilities of a vehicle-agent mobile device). In some embodiments, a gate may be opened upon verification that a vehicle agent (or vehicle or mobile device thereof) is at, or within a specified distance from, a gate. For example, a server may be configured to open a gate when it determined that a vehicle agent is at the gate by authenticating the geolocation of the vehicle-agent mobile device relative to the location of the gate. In some embodiments, the server may be configured to log a gate event (i.e., opening or closing thereof). It is to be appreciated that, according to some embodiments, a server may be configured to provide access credentials to a vehicle-agent device, or it may communicate with access control facilities directly. For example, and with further reference to FIG. 28, system 2800 may include one or more access control facilities 2850 (such as a gate, a lock, a garage door, etc.) which may be operatively connected to server 2810 via network 2820 and which may provide access to a parking space or location (such as a driveway, a garage, a neighborhood, a parking lot or structure, etc.).

According to some embodiments, a space record may comprise details about a residential parking space, such as location, current availability (e.g., available or occupied), future availability (e.g., day(s)/time(s) of availability), parking size, location type (e.g., driveway or street), charger availability and type, and environmental descriptors such as lighting availability (e.g., no lighting, well lit), parking position (e.g., left side of driveway), security availability (e.g., cameras and/or patrol), information about corresponding listing agent, etc. In some embodiments, a parking space may require approval prior to being listed for reservation. For example, a listing agent may be required to provide details about a residential parking space and the space details may need to be reviewed and approved before the listing agent can list the space.

According to some embodiments of the present invention, a space record may comprise data about a public or commercial parking space and/or lot, such as a tenant ID, a parking rate, a location boundary, and one or more unique codes. In some embodiments, a server may be configured to grant access to a parking lot (or structure) by authenticating a code. For example, a vehicle agent may have to scan a QR code to enter a parking lot. According to some embodiments, the server may be configured to determine whether a vehicle agent is on the premises of a parking lot, such as when a QR code is scanned or when the geolocation of the vehicle-agent mobile device is determined to be within a defined boundary. In some embodiments, a parking rate may be determined by a location of a vehicle agent. For example, if a vehicle agent reserves and parks in a parking space designated for a specific store, the vehicle agent may be charged an on-premise rate while the vehicle agent is in the store (verified by the geolocation of the vehicle-agent mobile device, or via QR or RFID verification, for example). However, if the vehicle leaves the store and decides to stay parked in the parking space, the vehicle agent may be charged an off-premise rate. Once a vehicle agent is no longer within a defined boundary (e.g., has left the store), a rate change delay may take effect during which an on-premise rate may be charged for period of time or while the vehicle agent remains within specified distance from the boundary before an off-premise rate is charged (e.g., to give them time to walk to their vehicle). In some embodiments, an on-premise rate may be applied while a vehicle agent is parked in a space and an off-premise rate may be applied when the vehicle agent has left the space but still within the parking lot (which, in some embodiments, may take effect only after the expiration of the grace period). In some embodiments, the server may be configured to send a notification to a vehicle-agent mobile device warning the vehicle agent that they are being, or soon will be, charged an off-premise rate.

It is to be understood that variations, modifications, and permutations of embodiments of the present invention may be made without departing from the scope thereof. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention. More particularly, it is to be appreciated that the application may be configured, or otherwise adapted, to integrate third-party technologies to improve the features of the application. For example, the application may integrate rideshare applications (e.g., Uber and Lyft) which may allow for vehicle operators to be driven to and from charging stations. As another example, the application may integrate map and/or traffic applications which may direct vehicle operators to charging stations, as well as provide trip duration estimates which may be used to determine when a vehicle operator is notified to depart from a location.

### FURTHER EMBODIMENTS

Further to the above, in some embodiments, using the application, a station owner may create an account as an owner user and register one or more charging stations and/or parking spaces. The owner user may also set up their preferred payment option by providing their bank or intermediary service information (e.g., account and routing numbers) in order to receive payments for rentals. In some embodiments, the owner user may view the status of a charging station or parking space, as well as view related data and analytics, at any time. In some embodiments, the owner user may optionally designate one or more managers to one or more charging stations or parking spaces by sending a request to a designated station manager (e.g., via email) to create an account.

Further to the above, in some embodiments, using the application, a station manager may create an account as a manager user by invitation from an owner user. The manager user may, in one aspect, be able to add charging stations and parking spaces. In other aspects, the manager user may also be able to edit and remove charging stations and parking spaces. In some embodiments, the manager user may be able to monitor requests to rent a charging station or parking space and approve or deny the requests in the application. The manager user may also be able to update the status of a charging station or parking space, as well as monitor payment transactions.

Further to the above, in some embodiments, using the application, a vehicle user may register an account, set up payment information, and set up their vehicle information. A vehicle user may also be able to view registered charging and/or parking spaces. In some embodiments, an exact location of a space may not be provided until after a request is made and approved. A vehicle user may be able to view a map which, in some embodiments, may show available chargers along a current or planned route. In some embodiments, a vehicle user may be able to view the types of chargers available.

According to some embodiments, a vehicle user may be able to view temporarily unavailable chargers or parking spaces and the time(s) that they will be available. A vehicle user may be able to reserve a charger or parking space which, in some embodiments, may done on-demand (to reserve a nearby charger, for example) or in advance (to reserve a charger along a route of a planned trip, for example). In some embodiments, a vehicle user may scan a QR code affixed to a charger with a camera of a mobile device to reserve the charger (if not already reserved) or initiate a charge (if already reserved).

According to some embodiments, after a vehicle user completes a charge, payment may be facilitated through the application. In some embodiments, a Bluetooth-based meter may evaluate energy consumption during a charge. The charge fee may, in some embodiments, be timed-based. Other fees may be applied to the vehicle user, such as a connection fee which, in some embodiments, may be percentage of a subtotal to be charged. In some embodiments, a time-of-use fee may apply, such as when a vehicle user charges their vehicle during peak energy consumption hours.

According to some embodiments, if a vehicle user leaves their vehicle parked in charging space after charging is finished (and, in some embodiments, after a time threshold is reached), the vehicle user may be charged according to a defined parking rate. In some embodiments, while a vehicle is charging, a vehicle user may view a payment meter and charging time meter and may, in some embodiments, be able to add more charging time.

According to some embodiments, a vehicle user may reserve and pay for a parking space through the application. In some embodiments, a parking space rate may be determined by one or more factors such as the parking location, day of the week, time of day, or the vicinity of the parking space to a destination. In some embodiments, these factors may be integrated into a time-based fee for a parking space or these factors may be applied as a premium charged in addition to the time-based fee. According to some embodiments, all or a part of the total fee may be paid at the time of the rental, upon arrival to the parking space, or upon departure from the parking space. In some embodiments, a vehicle user may have an option to pay for additional time.

According to some embodiments, a user may post a location of their current parking space and offer it to other users. In some embodiments, a user may “pin” their location on a map, provide a photograph and/or manual description of the location, or use the GPS location of their mobile device or vehicle, as well as provide any other additional details. In some embodiments, users can search for parking spaces posted by others and reserve the parking space for when the current occupant leaves the space.

According to some embodiments, a system for managing rental of charging/parking spaces and/or parking spaces may include one or more electric vehicle chargers, one or more QR labels, one or more servers, and a mobile device which may be GPS-enabled and may comprise a camera configured to scan QR codes and capture photographs of stations/parking spaces and apply geotags. In some embodiments, the system may include a computer which may be configured to execute a web-based application.

According to some embodiments and implementations, a charging station owner may establish an account and configure their charging station. In some embodiments, this may include providing the charging station location, technical details, rates (fixed or time variable), cord length, connector type, day/time availability, and/or special accessibility features (i.e., garage, maneuverability concerns). The charging station owner may also, according to some embodiments, facilitate an API connection between the charging station (or charging station network) and application network. In some embodiments, the charging station owner may optionally facilitate an API connection to their power company or solar charge controller for scheduling based on demand or solar production. Likewise, and according to some embodiments, a charging station owner may facilitate an API connection to their garage door network. In some embodiments, a charging station owner may configure a deposit account or intermediary accounting for receiving and/or making payments. According to some embodiments, an API may be established directly between a charging station network and application network, or there may be one or more intermediary API brokers. In some embodiments, a charging station owner may establish one or more charging station operators which may be responsible for approving/rejecting rentals requests and may view a status of their assigned charging station.

According to some embodiments, an electric vehicle operator may establish an account on the application which may include providing a payment method, the make/model of their electric vehicle, a license plate and/or VIN, and charging preferences (such as L1, L2, charge speed). In some embodiments, the electric vehicle user may have a mobile device with its GPS allowed. The application, in some embodiments, may also interface with a mobile device camera (for photographing the operator's vehicle, for example) and microphone (for in-application communication, for example).

According to some embodiments, an electric vehicle charger may be commercially available (e.g., Tesla, Leviton, Enphase, ChargePoint, Emporia, Siemens, etc.), but must be internet-connected with API access for retrieving status and data and configuring a charger in order to turn it on and off (API direct to charger or to charger network). In some embodiments, a charger may be proprietary to the application network and may, therefore, be pre-configured to be operated by the application. In some embodiments, a charger may have a label or sticker (or the like) with a QR code for identifying or configuring the charger via the application.

According to some embodiments, the application may connect to an electric vehicle via an API to access its current location, state of charge, charging speed and capacity limits.

In some embodiments, the application may interface with one or more rideshare applications (e.g., Uber, Lyft, etc.) to drop off or pick up electric vehicle operators to and from a location.

In some embodiments, the application may interface with map or traffic applications (e.g., Google Maps, Waze).

According to some implementations, when an electric vehicle operator wants to schedule a charge, they may search for available chargers based on location and day/time (or based on optional filters for charger technical details such as speed, connector type, community ratings, community submitted photos of charging station, etc.). In some embodiments, the electric vehicle operator may request a charging station rental and the rental may be sent to the charging station operator. In some embodiments, a rental request may be directed to a single charging station, multiple selected charging stations, or all charging stations within a geographic range or which satisfy search criteria. According to some embodiments, a rental may include the time of stay, which may be calculated based on user input or API received state of charge, target state of charge, charger speed, or absolute value. In some embodiments, if an absolute value and charge finishes early, an electric vehicle user may be subject to a parking surcharge.

According to some embodiments, a charging station operator(s) may receive a rental request and approve or reject the request. In some embodiments, if the request is not approved within a certain period of time, it may be treated as a rejection. The first charging station operator to accept a rental gets the rental. According to some embodiments, an electric vehicle operator may be notified of a rental approval and the application may be configured with the date/time/location, and the application may notify the electric vehicle operator when it is time to head to the charging station (which can be based on location of the vehicle operator and expected travel time).

According to some embodiments, when the electric vehicle operator arrives and parks, they may either “check in” or there may be a geofencing check in option. Next, they may plug in their electric vehicle and wait for the system to verify authorization (i.e., verify that the electric vehicle and charging station match the rental). Once verified, the charging station may be instructed to start charging. In some embodiments, the electric vehicle operator may be notified via the application of the status of the charge, including total charge delivered, elapsed time, estimated remaining charge, estimated remaining time, charge speed, etc. According to some embodiments, any malfunctions or early stops to the charging process may be reported to the electric vehicle operator and the charging station operator. In some embodiments, the electric vehicle operator may be notified when they should leave to retrieve the electric vehicle based on charging status and traffic. After a grace period, and according to some embodiments, a parking surcharge may be imposed. In some embodiments, a penalty may be imposed if a late pickup causes scheduling problems with scheduled rentals. According to some embodiments, there may exist a two-way messaging feature between the charging station operator and electric vehicle operator. In some embodiments, this feature may include status and indicate whether there are problems, emergencies, etc. Once charging is completed, according to some embodiments, the electric vehicle operator may disconnect their electric vehicle and the application may send a summary of charge details and may ask for a review/rating. Similarly, the charging station owner may be asked to review/rate the electric vehicle operator. In some embodiments, a geolocation may be used to determine when the electric vehicle leaves the premises (instead of just disconnecting and remaining parking).

According to some embodiments and implementations, the systems and processes for reserving a parking space may be similar to the above-described systems and processes as applied to reserving a charging station, but without the involvement of a charging station. In some embodiments, because a charging station isn't involved, there may be more of a focus on the geolocation of the vehicle operator or vehicle (if connected via an API). According to some embodiments, the vehicle operator may need to take photographs of their vehicle in a space to visually confirm that the vehicle is in the correct space (which may be reviewed by the parking space operator for approval).

According to some embodiments, the application may be used to exchange a parking space between a first vehicle operator and a second vehicle operator. According to some implementations, the first vehicle operator may park in a space and geotag the location in the application and may, in some embodiments, capture and provide a picture clearly showing the space location and the first vehicle operator's vehicle. In some embodiments, the first vehicle operator may capture and provide a photograph of themselves. According to some embodiments, the first vehicle operator may provide an estimate of when they are expecting to leave the space, and offers the space to other user. Following, the second vehicle operator may search for spaces available at a location and within a time window. If the second vehicle operator wants to reserve a space, they may send a request (for a single space or multiple space in an area) which may include an expected time of arrival. Next, the first vehicle operator (and/or others) may receive the request for the rental and the first operator to accept the rental gets the rental. Following, at a designated time, the first vehicle operator and the second vehicle operator may be at the space at the same time. In some embodiments, if the first vehicle operator is late, there may be a penalty and/or the second vehicle operator may be able to cancel. In some embodiments, if the second vehicle operator is late, there may be a penalty and/or the first vehicle operator may be able to cancel. According to some embodiments, there may be other situations which may give rise to cancellation penalty or fee. For example, if the first vehicle operator decides they don't want to leave, they may have to pay a penalty (a portion of which may go to the second vehicle operator). Once the parking space exchange occurs, both the first vehicle operator and the second vehicle operator may confirm the exchange via the application. In some embodiments, the GPS location of the vehicles may be tracked to ensure that first vehicle operator moved their vehicle from the space and the second vehicle operator moved their vehicle into the space. In some embodiments, QR codes, lighted signs, or internet-enabled lighted signs may be provided to be placed in the vehicle to identify the space. In some embodiments, a lighted sign may light up or flash when the second vehicle operator is nearby. In some embodiments, a lighted sign may also be GPS-enabled to guide the second vehicle operator to the exact location of the space.

What is claimed is:

1. A system for managing and coordinating reservations of parking spaces, comprising:
a) a remote server having a processor, processor-executable instructions stored in a memory associated with said processor, and a storage element associated with said processor, said storage element comprising:
i) a space-record database for storing a plurality of space records;
ii) a user-record database for storing a plurality of user records; and
iii) a reservation-record database for storing a plurality of reservation records;
b) a listing-agent device operatively connected to said server; and
c) a vehicle-agent device operatively connected to said server, said vehicle-agent device comprising a location module for determining a location of said vehicle-agent device and a camera module for obtaining an image;
wherein said instructions are configured to cause said processor to:
create a space record in response to receiving a listing request from said listing-agent device;
modify a space record in response to receiving a listing update from said listing-agent device;
identify available parking spaces in response to receiving a space availability query from said vehicle-agent device, and provide said available spaces to said vehicle-agent device;
create a reservation record associated with a corresponding space record and a corresponding user record in response to receiving a reservation request from said vehicle-agent device; and
validate a start of a reservation and initiating a timer in response to receiving a start-verification from said vehicle-agent device.

2. The system of claim 1, wherein said vehicle-agent device is configured to send a discrepancy package to said server, said discrepancy package comprising a location and an image of an observed parking space associated with a space record, and
wherein said server instructions are further configured to cause said processor to compare said discrepancy package with an availability status of a space record corresponding to said parking space, and, as a result of said comparison, modify said corresponding space record and said reservation record.

3. The system of claim 2, wherein said server instructions are further configured to cause said processor to send a notification to said listing-agent device, said notification identifying a change in said availability status of said space record as a result of said discrepancy package.

4. The system of claim 2, wherein, when said parking space is observed to be available and said availability status of said space record is “unavailable”, said server instructions are further configured to cause said processor to modify said space record to change said availability status to “temporarily withheld” to indicate that said parking space is exclusively available for reservation by said vehicle-agent device.

5. The system of claim 4, wherein said server instructions are further configured to cause said processor to, in response to receiving a reservation request from said vehicle-agent device:
modify said reservation record to associate said reservation record with said space record; and
if a parking space was previously reserved by said vehicle-agent device, change an availability status of a space record corresponding to said previously reserved parking space to “available”.

6. The system of claim 4, wherein said server instructions are further configured to cause said processor to change said recorded status to “available” if said server fails to receive from said vehicle-agent device a reservation request before the expiration of a temporary hold time.

7. The system of claim 2, wherein said server is configured to log a parking violation associated with said space record and send a notification identifying said parking violation to said listing-agent device, when said parking space is observed to be unavailable and said availability status of said space record is “available”.

8. The system of claim 7, wherein said listing-agent device is configured to send a violation verification package to said server, said violation package comprising an image and a location of said parking violation associated with said space record,
wherein said server is configured to:
log a confirmation of said parking violation based on said violation package; and
determine if said parking violation was committed by a violating user in said user-record database.

9. The system of claim 8, wherein said server is configured to send a notification to a vehicle-agent device associated with said violating user, said notification identifying at least one of the group consisting of a demand for payment and a warning that a vehicle associated with said violating user may be towed.

10. The system of claim 8, wherein said server is configured to dispatch a towing service to tow said vehicle.

11. The system of claim 1, wherein said reservation record comprises a maximum reservation time,
wherein said server is configured to monitor an elapsed time determined by said timer of a reservation associated with said reservation record,
wherein, if said elapsed time exceeds said maximum reservation time, a time violation occurs, and
wherein, if said time violation occurs, said server is configured to send a notification to said vehicle-agent device, said notification identifying said time violation and that a surcharge will apply to said reservation.

12. The system of claim 1, wherein said space record comprises an indication of whether a corresponding parking space has electric vehicle charging facilities and a cost associated with charging,
wherein said reservation record comprises an indication of whether said charging facilities will be used during said reservation,
wherein said server is configured to:
log charge-status data; and
send one or more notifications to said vehicle-agent device indicating a change in a status of said charging facilities.

13. The system of claim 12, wherein said server is configured to:
calculate a charging cost based on said charge-status data;
calculate a reservation cost based on said charging cost and an elapsed time determined by said timer; and
update said reservation record to include said reservation cost.

14. The system of claim 1, wherein said server is configured to send route data to said vehicle-agent device, said route data comprising directions from said vehicle-agent device to a location associated with said reservation record,
wherein a user interface of said vehicle-agent device is configured to display a map and route guidance based on said route data, and
wherein said vehicle-agent device is configured to periodically send location information associated with said vehicle-agent device to said server.

15. The system of claim 1, wherein, said server is configured to end said reservation when a geolocation of said vehicle-agent device is within a specified distance from a location associated with said reservation record or said server receives a request to end said reservation from said vehicle-agent device.

16. The system of claim 15, wherein said user record comprises at least one pre-authorized payment method and wherein said server is configured to:
calculate a reservation cost;
facilitate payment from said vehicle-agent device; and
facilitate payment to said listing-agent device.

17. The system of claim 1, wherein said space record comprises an indicator of whether said space has access control facilities,
wherein said server is configured to:
issue and send an access credential to one of the group consisting of said vehicle-agent device or said access control facilities when a geolocation of said vehicle-agent device is within a specified distance from said access control facilities; and
log an event corresponding to the opening of said gate.

18. The system of claim 1, wherein said space record comprises a parking size, a location type, a charger descriptor, and environment descriptors.

19. The system of claim 1, wherein said space record comprises a tenant identifier, an on-premise rate, an off-premise rate, and a boundary of a premise,
wherein said server is configured to:
update said reservation record to charge said on-premise rate when said vehicle-agent device is within said boundary; and
update said reservation record to charge said off-premise rate when said vehicle-agent device is outside of said boundary.

20. The system of claim 19, wherein said space record comprises a rate change delay and wherein said server is configured to update said reservation record to charge said on-premise rate for a duration of said delay when said vehicle-agent device is outside of said boundary.
